(19) United States
(12) Patent Application Publication
(10) Pub. No.: US 2026/0222750 A1
(43) Pub. Date: Jul. 30, 2026

(54) INFORMATION PROCESSING SYSTEM, INFORMATION PROCESSING METHOD, AND AUDIO REPRODUCTION DEVICE

(71) Applicant: Sony Group Corporation, Tokyo (JP)

(72) Inventors: Kyosuke MATSUMOTO, Tokyo (JP); Takahiro KATAGIRI, Tokyo (JP)

(73) Assignee: Sony Group Corporation, Tokyo (JP)

(21) Appl. No.: 19/148,015

(22) PCT Filed: Mar. 25, 2024
(86) PCT No.: PCT/JP2024/011763

§ 371 Date: Jul. 15, 2025

(30) Foreign Application Priority Data
Mar. 31, 2023 (JP) 2023-059481

(51) Int. Cl. H04R 25/00

(52) U.S. Cl. CPC H04R 25/70; H04R 25/505; H04R 25/558; H04R 2225/41; H04R 2225/43; H04R 2225/55

(57) ABSTRACT

Provided is an information processing system including: circuitry configured to acquire fitting data corresponding to a hearing aid; acquire device information for an output device that at least outputs audio; generate at least one audio processing parameter for the output device based on the fitting data and the device information; and provide information to the output device to output audio based on the at least one audio processing parameter.

### TECHNICAL FIELD

The present disclosure relates to an information processing system, an information processing method, and an audio reproduction device.

### BACKGROUND ART

Hearing aids are widely used as a device for compensating for a user's hearing. For example, a hearing aid is formed by a microphone, a receiver, and the like, and is put on a body part of the user. The hearing aid collects sounds around the user, performs processing such as amplification on the collected sounds according to the auditory characteristics of the user, and outputs the sounds to the user.

### CITATION LIST

### Patent Literature

PTL 1: Japanese Laid-open Patent Publication No. 2008-11527

### SUMMARY OF INVENTION

### Technical Problem

In a case where a user who uses a hearing aid enjoys contents of movies or music using a sound reproduction apparatus (auditory device) such as a television device or an audio device, the user listens to sounds from a speaker of the sound reproduction apparatus via the hearing aid, for example. In this case, since the hearing aid is often inferior in the quality of reproduced sounds to consumer sound reproduction apparatuses, the user may not be able to enjoy high-quality sounds even if the high-quality sounds are output from the sound reproduction apparatus.

In addition, in a case where the user directly listens to sounds from the speaker of the sound reproduction apparatus without using the hearing aid, the user will not be able to enjoy the sounds satisfactorily since no hearing aid processing according to the auditory characteristics of the user is performed on the sounds.

Some consumer sound reproduction apparatuses may have a function of adjusting reproduced sounds, which serves as a partial substitute for the hearing aid processing. Therefore, the user may listen to and enjoy high-quality sounds directly from such a sound reproduction apparatus. However, it is very complicated to finely adjust such a sound reproduction apparatus according to the auditory characteristics of the user.

The present disclosure proposes an information processing system, an information processing method, and an audio reproduction device that enable a user to listen to sounds from a sound reproduction apparatus that is adjusted according to the auditory characteristics of the user without performing complicated adjustments.

### Solution to Problem

According to the present disclosure, there is provided an information processing system including: circuitry configured to acquire fitting data corresponding to a hearing aid; acquire device information for an output device that at least outputs audio; and generate at least one audio processing parameter for the output device based on the fitting data and the device information; and provide information to the output device to output audio based on the at least one audio processing parameter.

Furthermore, according to the present disclosure, there is provided an information processing method, including: acquiring, with circuitry, fitting data corresponding to a hearing aid; acquiring, with the circuitry, device information for an output device that at least outputs audio; generating, with the circuitry, at least one audio processing parameter for the output device based on the fitting data and the device information; and providing, with the circuitry, information to the output device to output audio based on the at least one audio processing parameter.

Furthermore, according to the present disclosure, there is provided an audio reproduction device, including: circuitry configured to: receive at least one audio processing parameter via a network; process audio using the at least one audio processing parameter to generate processed audio; and output the processed audio as sound, wherein the at least one audio processing parameter is determined based on hearing aid fitting information and device information of the audio reproduction device.

### BRIEF DESCRIPTION OF DRAWINGS

FIG. 1 is a diagram illustrating a schematic configuration of a hearing aid system 1 according to an embodiment of the present disclosure.

FIG. 2 is a block diagram for describing functional blocks of a hearing aid 2 and a charger 3 according to the embodiment of the present disclosure.

FIG. 3 is a block diagram for describing functional blocks of an information processing terminal 40 according to the embodiment of the present disclosure.

FIG. 4 is an explanatory diagram (part 1) for describing an outline of the embodiment of the present disclosure.

FIG. 5 is an explanatory diagram (part 2) for describing an outline of the embodiment of the present disclosure.

FIG. 6 is an explanatory diagram (part 3) for describing an outline of the embodiment of the present disclosure.

FIG. 7 is a diagram illustrating a schematic configuration of a hearing aid system 5 according to a first embodiment of the present disclosure.

FIG. 8 is a block diagram for describing functional blocks of a server 90 according to the first embodiment of the present disclosure.

FIG. 9 is a block diagram for describing functional blocks of the hearing aid 2 according to the first embodiment of the present disclosure.

FIG. 10 is a block diagram for describing functional blocks of a sound reproduction apparatus 50a according to the first embodiment of the present disclosure.

FIG. 11 is a block diagram for describing functional blocks of a sound reproduction apparatus 50b according to the first embodiment of the present disclosure.

FIG. 12 is a sequence diagram of a processing method according to the first embodiment of the present disclosure.

FIG. 13A is an explanatory diagram (part 1) for describing the processing method according to the first embodiment of the present disclosure.

FIG. 13B is an explanatory diagram (part 2) for describing the processing method according to the first embodiment of the present disclosure.

FIG. 14 is an explanatory diagram (part 3) for describing the processing method according to the first embodiment of the present disclosure.

FIG. 15 is an explanatory diagram (part 4) for describing the processing method according to the first embodiment of the present disclosure.

FIG. 16 is an explanatory diagram (part 5) for describing the processing method according to the first embodiment of the present disclosure.

FIG. 17 is an explanatory diagram (part 6) for describing the processing method according to the first embodiment of the present disclosure.

FIG. 18 is an explanatory diagram (part 7) for describing the processing method according to the first embodiment of the present disclosure.

FIG. 19 is a block diagram for describing functional blocks of a sound reproduction apparatus 50c according to a modification of the first embodiment of the present disclosure.

FIG. 20 is a diagram (part 1) illustrating a schematic configuration of a hearing aid system 5 according to a second embodiment of the present disclosure.

FIG. 21 is a diagram (part 2) illustrating a schematic configuration of the hearing aid system 5 according to the second embodiment of the present disclosure.

FIG. 22 is a diagram (part 3) illustrating a schematic configuration of the hearing aid system 5 according to the second embodiment of the present disclosure.

FIG. 23 is a diagram (part 4) illustrating a schematic configuration of the hearing aid system 5 according to the second embodiment of the present disclosure.

FIG. 24 is a diagram (part 5) illustrating a schematic configuration of the hearing aid system 5 according to the second embodiment of the present disclosure.

FIG. 25 is a diagram illustrating an example of data utilization.

FIG. 26 is a diagram illustrating an example of data.

FIG. 27 is a diagram illustrating an example of cooperation with other devices.

FIG. 28 is a diagram illustrating an example of application transition.

### DESCRIPTION OF EMBODIMENTS

Favorable embodiments of the present disclosure will be described in detail with reference to the appended drawings. Note that, in the present specification and drawings, redundant description of a configuration element having substantially the same functional configuration is omitted by providing the same sign. In addition, in the present specification and the drawings, a plurality of components having substantially the same or similar functional configurations may be distinguished from one another by affixing different alphabets to the same reference numeral. However, when it is not particularly necessary to distinguish the plurality of components having substantially the same or similar functional configurations, they are denoted with only the same reference numeral.

The drawings referred to in the following description are drawings for promoting the description and understanding of an embodiment of the present disclosure, and shapes, dimensions, ratios, and the like illustrated in the drawings may be different from actual ones for the sake of clarity. The apparatuses illustrated in the drawings can be modified in design as appropriate in consideration of the following description and known techniques.

The description will be given in the following order.
1. Outline of Hearing Aid System
2. BACKGROUND
3. First Embodiment
3.1 Hearing Aid System
3.2 Server
3.3 Hearing Aid
3.4 Sound Reproduction Apparatus
3.5 Processing Method
3.6 Generation of Parameters
3.7 Modifications
3.8 Use of Reward Predictor
4. Second Embodiment
5. Conclusion
6. Example of Data Utilization
7. Example of Cooperation with Other Devices
8. Example of Application Transition
9. Supplement

### 1. Outline of Hearing Aid System

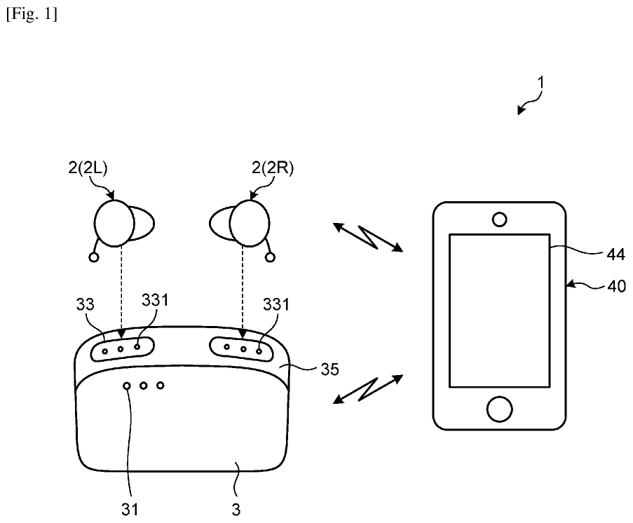

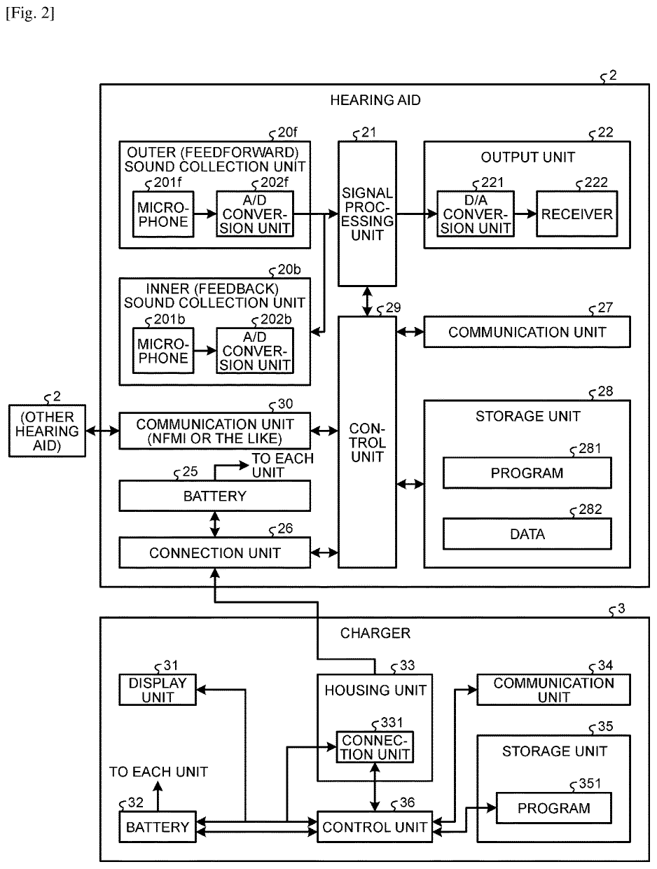

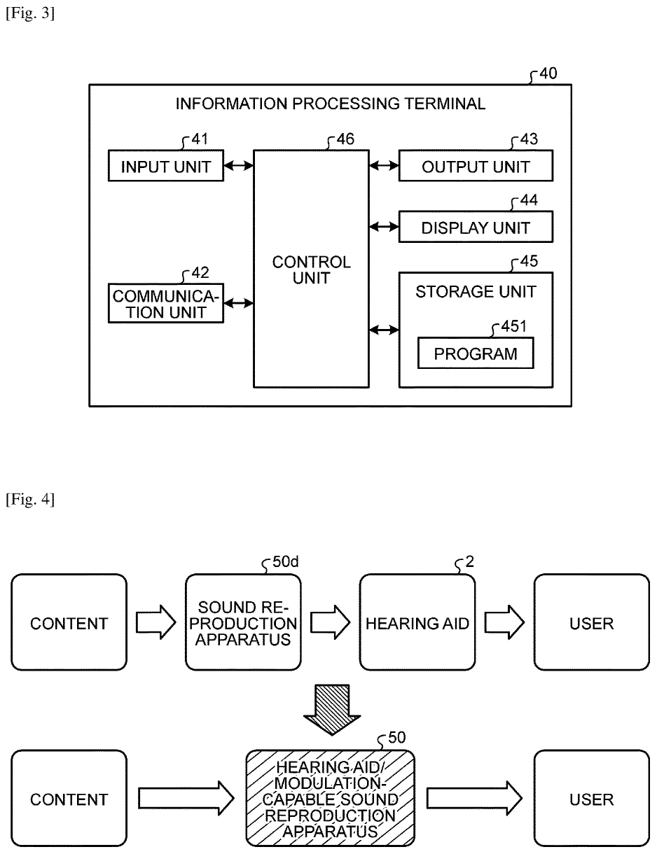

First, an outline of a hearing aid system 1 according to an embodiment of the present disclosure will be described with reference to FIGS. 1 to 3. FIG. 1 is a diagram illustrating a schematic configuration of the hearing aid system 1 according to an embodiment of the present disclosure, and FIG. 2 is a block diagram for describing functional blocks of a hearing aid 2 and a charger 3 according to the embodiment of the present disclosure. FIG. 3 is a block diagram for describing functional blocks of an information processing terminal 40 according to the embodiment of the present disclosure.

As illustrated in FIG. 1, the hearing aid system 1 according to the embodiment of the present disclosure includes a pair of left and right pieces of the hearing aid 2, the charger 3 (charging case) that houses the hearing aid 2 and electrically charges the hearing aid 2, and the information processing terminal 40 such as a smartphone capable of communicating with at least one of the hearing aid 2 and the charger 3. Hereinafter, each device included in the hearing aid system 1 according to the embodiment of the present disclosure will be described in sequence. In the following description, it is assumed that the hearing aid 2 is constituted by a pair of pieces. However, the embodiment of the present disclosure is not limited thereto, and may be a monaural type of which the hearing aid 2 is attached to one of left and right ears.

First, a functional configuration of the hearing aid 2 will be described. In the embodiment of the present disclosure, at least a part of the hearing aid 2 can be configured to be attached to a part of the ear canal of the user, for example. The appearance of the hearing aid 2 according to the embodiment of the present disclosure will be described later. As illustrated in FIG. 2, the hearing aid 2 mainly includes a sound collection unit 20 (20b and 20f), a signal processing unit 21, an output unit 22, a battery 25, a connection unit 26, communication units 27 and 30, a storage unit 28, and a control unit 29.

The sound collection unit 20 includes an outer (feedforward) sound collection unit 20f that collects sounds in the outer region of the ear canal and an inner (feedback) sound collection unit 20b that collects sounds in the inner region of the ear canal. The hearing aid 2 according to the embodiment of the present disclosure may be provided with at least the outer sound collection unit 20f that collects sounds in the outer region of the ear canal. Each sound collection unit 20 includes a microphone (hereinafter, also called mic) 201 and an analog/digital (A/D) conversion unit 202. The mic 201 collects sounds, generates an analog sound signal (acoustic signal), and outputs the analog sound signal to the A/D conversion unit 202. The A/D conversion unit 202 performs digital conversion processing on the analog sound signal input from the mic 201, and outputs the digitized sound signal to the signal processing unit 21.

Under the control of the control unit 29 described later, the signal processing unit 21 performs predetermined signal processing on the digital sound signal input from the sound collection unit 20, and outputs the digital sound signal to the output unit 22. Examples of the predetermined signal processing include a filtering process of separating a sound signal into each predetermined frequency band, an amplification process of amplifying the sound signal by a predetermined amount of amplification in each predetermined frequency band in which the filtering process has been performed, a noise reduction process, a howling cancellation process, and the like. The signal processing unit 21 can include a memory and a processor having hardware such as a digital signal processor (DSP), for example.

The output unit 22 includes a digital/analog (D/A) conversion unit 221 and a receiver 222. The D/A conversion unit 221 performs analog conversion processing on the digital sound signal input from the signal processing unit 21 and outputs the digital sound signal to the receiver 222. The receiver 222 outputs an output sound (sound) corresponding to the analog sound signal input from the D/A conversion unit 221. The receiver 222 can be constituted by a speaker or the like, for example.

The battery 25 supplies power to each unit constituting the hearing aid 2. The battery 25 can be constituted by a rechargeable secondary battery such as a lithium ion battery, for example. The battery 25 can be charged by power supplied from the charger 3 via the connection unit 26.

For example, when the hearing aid 2 is housed in the charger 3, the connection unit 26 is connected to the connection unit of the charger 3 to receive power and various types of information from the charger 3 and output various types of information to the charger 3. The connection unit 26 can be constituted by one or a plurality of pins, for example.

The communication unit 27 can communicate with the charger 3 or the information processing terminal 40 according to a predetermined communication standard via a communication network under the control of the control unit 29. The predetermined communication standard here is assumed to be Wi-Fi (registered trademark), Bluetooth (registered trademark), or the like, for example. The communication unit 27 can be constituted by a communication module or the like, for example. The communication unit 30 can communicate with the other piece of the hearing aid 2 by short-range communication such as near field magnetic induction (NFMI) under the control of the control unit 29.

The storage unit 28 stores various types of information on the hearing aid 2. The storage unit 28 can be constituted by a random access memory (RAM), a read only memory (ROM), a memory card, and the like, for example. The storage unit 28 can store a program 281 to be executed by the hearing aid 2 and various types of data 282 to be used by the hearing aid 2. Examples of the data 282 include the age of the user, the presence or absence of experience in using the hearing aid 2 by the user, the gender of the user, and the like. Further examples of the data include the time of the user's using the hearing aid 2 that is measured by a time measurement unit (not illustrated). The time measurement unit is provided inside the hearing aid 2, and can measure date and time and output a time measurement result to the control unit 29 and the like. The time measurement unit can be constituted by a timing generator, a timer having a time measurement function, or the like, for example.

The control unit 29 controls each unit constituting the hearing aid 2. The control unit 29 can be constituted by a memory and a processor having hardware such as a central processing unit (CPU) or a digital signal processor (DSP), for example. The control unit 29 reads and executes the stored program 281 in the work area of the memory, and controls each component and the like through execution of the program by the processor.

Although not illustrated in FIG. 2, the hearing aid 2 may have an operation unit. The operation unit can receive an input of an activation signal (trigger signal) for activating the hearing aid 2 and output the received activation signal to the control unit 29. The operation unit can be constituted by a push switch, a button, a touch panel, or the like, for example.

The hearing aid 2 may also be equipped with a biological information sensor (not illustrated) which is a non-invasive sensor device capable of acquiring various kinds of biological information (sensing data) of the user. Examples of the biological information sensor include a blood flow sensor that detects the pulse, heart rate, blood flow, blood oxygen, and the like of the user.

The hearing aid 2 may further be equipped with an inertial measurement unit (IMU) (not illustrated) capable of acquiring information on the posture and motion of the user. Specifically, the IMU includes an acceleration sensor that is an inertial sensor acquiring acceleration, a gyro sensor (angular velocity sensor) that is an inertial sensor acquiring an angular velocity, and the like. The hearing aid 2 may have a vibration sensor (not illustrated) instead of the IMU or together with the IMU.

The hearing aid 2 may include a positioning sensor (not illustrated) capable of acquiring information on the location of the user. The positioning sensor is a sensor that detects the location of the target user wearing the hearing aid 2, and can be specifically a global navigation satellite system (GNSS) receiver or the like. In this case, the positioning sensor can generate sensing data indicating the latitude and longitude of the current location of the target user based on a signal from a GNSS satellite. The hearing aid 2 may be equipped with such a communication device as the positioning sensor since it is possible to detect the relative positional relationship among users from radio frequency identification (RFID), information on an access point of Wi-Fi, information on a radio base station, or the like, for example.

Next, a functional configuration of the charger 3 will be described. As illustrated in FIG. 2, the charger 3 mainly includes a display unit 31, a battery 32, a housing unit 33, a communication unit 34, a storage unit 35, and a control unit 36.

The display unit 31 displays various states of the hearing aid 2 under the control of the control unit 36. For example, the display unit 31 can display information indicating that the hearing aid 2 is being charged and information indicating that the hearing aid 2 is receiving various types of information from the information processing terminal 40. The display unit 31 can be constituted by a light emitting diode (LED) or the like, for example.

The battery 32 supplies power to each unit constituting the hearing aid 2 and the charger 3 housed in the housing unit 33 via a connection unit 331 provided in the housing unit 33. The battery 32 can be constituted by a secondary battery such as a lithium ion battery, for example.

If the hearing aid 2 has two left and right channels, the housing unit 33 individually houses the two pieces of the hearing aid 2. The hearing aid 2 may be a monaural type. The housing unit 33 is provided with a connection unit 331 connectable to the connection unit 26 of the hearing aid 2. When the hearing aid 2 is housed in the housing unit 33, the connection unit 331 is connected to the connection unit 26 of the hearing aid 2 to transmit power from the battery 32 and various types of information from the control unit 36, receive various types of information from the hearing aid 2, and output the information to the control unit 36. The connection unit 331 can be constituted by one or a plurality of pins, for example.

The communication unit 34 communicates with the information processing terminal 40 according to a predetermined communication standard via a communication network under the control of the control unit 36. The communication unit 34 can be constituted by a communication module, for example.

The storage unit 35 stores various programs 351 to be executed by the charger 3. The storage unit 35 can be constituted by a RAM, a ROM, a flash memory, a memory card, and the like, for example.

The control unit 36 controls each unit constituting the charger 3. For example, when the hearing aid 2 is housed in the housing unit 33, the control unit 36 causes the hearing aid 2 to be supplied power from the battery 32 via the connection unit 331. The control unit 36 can be constituted by a memory and a processor having hardware such as a CPU or a DSP, for example. The control unit 36 reads and executes the programs 351 in the work area of the memory, and controls the components and the like through execution of the programs by the processor.

Next, a functional configuration of the information processing terminal 40 will be described. As illustrated in FIG. 3, the information processing terminal 40 mainly includes an input unit 41, a communication unit 42, an output unit 43, a display unit 44, a storage unit 45, and a control unit 46.

The input unit 41 receives inputs of various operations from the user, and outputs signals corresponding to the received operations to the control unit 46. The input unit 41 can be constituted by a switch, a touch panel, and the like, for example.

The communication unit 42 communicates with the charger 3 or the hearing aid 2 via a communication network under the control of the control unit 46. The communication unit 42 can be constituted by a communication module, for example.

The output unit 43 outputs sounds at a predetermined sound pressure level for each predetermined frequency band under the control of the control unit 46. The output unit 43 can be constituted by a speaker or the like, for example.

The display unit 44 displays various types of information on the information processing terminal 40 and information on the hearing aid 2 under the control of the control unit 46. The display unit 44 can be constituted by a liquid crystal display, an organic electroluminescent display (EL display), or the like, for example.

The storage unit 45 stores various types of information on the information processing terminal 40. The storage unit 45 stores various programs 451 and the like to be executed by the information processing terminal 40. The storage unit 45 can be constituted by a recording medium such as a RAM, a ROM, a flash memory, or a memory card, for example.

The control unit 46 controls each unit constituting the information processing terminal 40. The control unit 46 can be constituted by a memory and a processor having hardware such as a CPU, for example. The control unit 46 reads and executes the programs stored in the storage unit 45 in the work area of the memory, and controls the components and the like through execution of the programs by the processor.

The information processing terminal 40 may include a positioning sensor (not illustrated). The positioning sensor is a sensor that detects the location of the user carrying the information processing terminal 40, and can be specifically a GNSS receiver or the like. In this case, the positioning sensor can generate sensing data indicating the latitude and longitude of the current location of the user based on a signal from a GNSS satellite. The information processing terminal 40 may be equipped with such a communication device as the positioning sensor since it is possible to detect the relative positional relationship among users from RFID, information on an access point of Wi-Fi, information on a radio base station, or the like, for example.

The information processing terminal 40 may also be equipped with an imaging device (not illustrated). Specifically, the imaging device can include an imaging element (not illustrated) such as a complementary MOS (CMOS) image sensor, and a signal processing circuit (not illustrated) that performs imaging signal processing on a signal photoelectrically converted by the imaging element. The imaging device can further include an optical system mechanism (not illustrated) including an imaging lens, a diaphragm mechanism, a zoom lens, a focus lens, and the like, and a drive system mechanism (not illustrated) that controls the operation of the optical system mechanism. The information processing terminal 40 may further be equipped with an IMU (not illustrated) capable of acquiring information on the posture and motion of the user. The information processing terminal 40 may include a vibration sensor (not illustrated) instead of the IMU or together with the IMU.

In the embodiment of the present disclosure, the functional configurations of the hearing aid system 1 and each device included in the hearing aid system 1 are not limited to the forms illustrated in FIGS. 1 to 3. For example, the hearing aid system 1 may include a server or the like as described later.

In the embodiment of the present disclosure described below, the present disclosure is applied to the hearing aid system 1 as an example. However, the embodiment of the present disclosure is not limited to the application to the hearing aid system 1, and can also be applied to a system including another auditory device (for example, earphones, headphones, or the like).

### 2. Background

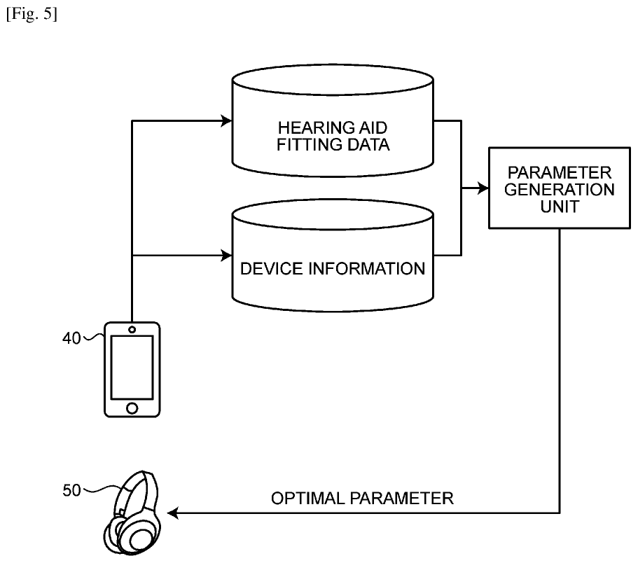

Next, the background leading to the creation of the embodiment of the present disclosure by the present inventors will be described with reference to FIGS. 4 to 6. FIGS. 4 to 6 are explanatory diagrams for describing an outline of the embodiment of the present disclosure.

In a case where a user who uses the hearing aid 2 enjoys contents of movies or music using a sound reproduction apparatus 50d such as a television device or an audio device, the user listens to the sounds from the speaker of the sound reproduction apparatus 50d via the hearing aid 2, for example, as illustrated in the upper part of FIG. 4. Alternatively, the user directly listens to the sound from the speaker of the sound reproduction apparatus 50d without using the hearing aid 2. In recent years, the user may listen to the sounds of contents that are streamed (distributed) to the hearing aid 2 and reproduced by the hearing aid 2.

In either case, however, the user may remain dissatisfied.

For example, in a case where the user listens to sounds from the speaker of the sound reproduction apparatus 50d without using the hearing aid 2, the user will not be able to enjoy the contents satisfactorily since no hearing aid processing according to the auditory characteristics of the user is performed on the sounds.

In addition, since the hearing aid 2 is a device intended to provide the user with environmental sounds around the user, the quality of reproduction sounds from the hearing aid 2 is often inferior to that of the consumer sound reproduction apparatus 50d. This is because, since the hearing aid 2 is a device intended to constantly provide the user with environmental sounds around the user, priority is given to providing sounds with low power consumption and low delay, and the sound quality has a lower priority than power consumption and delay.

Therefore, in a case where the user listens to sounds from the sound reproduction apparatus 50d via the hearing aid 2, since the sound quality is determined by the performance of the hearing aid 2, even if high-quality sounds are output from the sound reproduction apparatus 50d, the user will not be able to enjoy the high-quality sounds. Similarly, even in a case where the user listens to the sounds of contents streamed to the hearing aid 2 via the hearing aid 2, since the sound quality is determined by the performance of the hearing aid 2, even if high-quality sounds are streamed, the user will not be able to enjoy the high-quality sounds.

In recent years, some consumer sound reproduction apparatuses 50d may have a function of adjusting reproduced sounds (equalizer, audio enhancement function, or the like), which serves as a partial substitute for the hearing aid processing. Therefore, the user may listen to and enjoy high-quality sounds directly from such a sound reproduction apparatus 50d. However, it is very complicated to finely adjust such a sound reproduction apparatus 50d according to the auditory characteristics of the user. Therefore, even in the case of using such a sound reproduction apparatus 50d, the sound reproduction apparatus 50d cannot be favorably adjusted. As a result, the user cannot enjoy high-quality sounds.

In view of such circumstances, the present inventors have considered that it is necessary to provide a system in which the user of the hearing aid 2 can easily adjust the sound reproduction apparatus 50 according to his/her auditory characteristics, and have conducted intensive studies on such a system. Then, the present inventors have created embodiments of the present disclosure described below through the studies.

In the embodiment of the present disclosure created by the present inventors, as illustrated in the lower part of FIG. 4, it is possible to allow the user to enjoy high-quality sounds through hearing aid processing and the modulation processing in the sound reproduction apparatus 50 according to the auditory characteristics of the user.

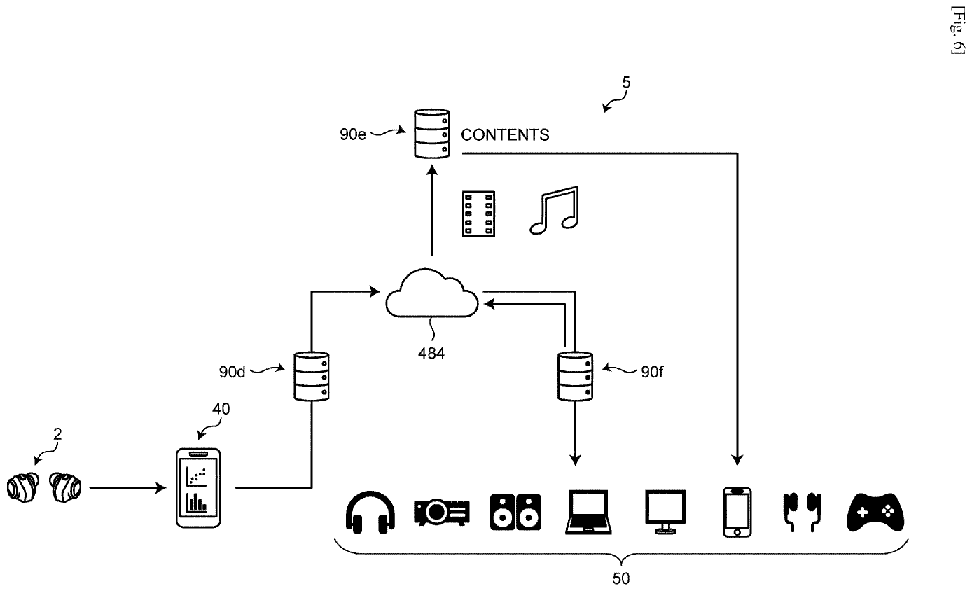

In the embodiments of the present disclosure created by the present inventors, as illustrated in FIG. 5, fitting data for the user to use the hearing aid 2 is automatically generated based on an input from the information processing terminal 40 used by the user, and parameters according to the auditory characteristics of the user are automatically generated by using device information of the sound reproduction apparatus 50 in a server (parameter generation unit in FIG. 5) or the like on a cloud. The server or the like on the cloud transmits the generated parameters to the sound reproduction apparatus 50, so that the user can use the sound reproduction apparatus 50 adjusted according to his/her auditory characteristics without performing complicated adjustments. As a result, according to the present embodiment, the user can enjoy high-quality sounds.

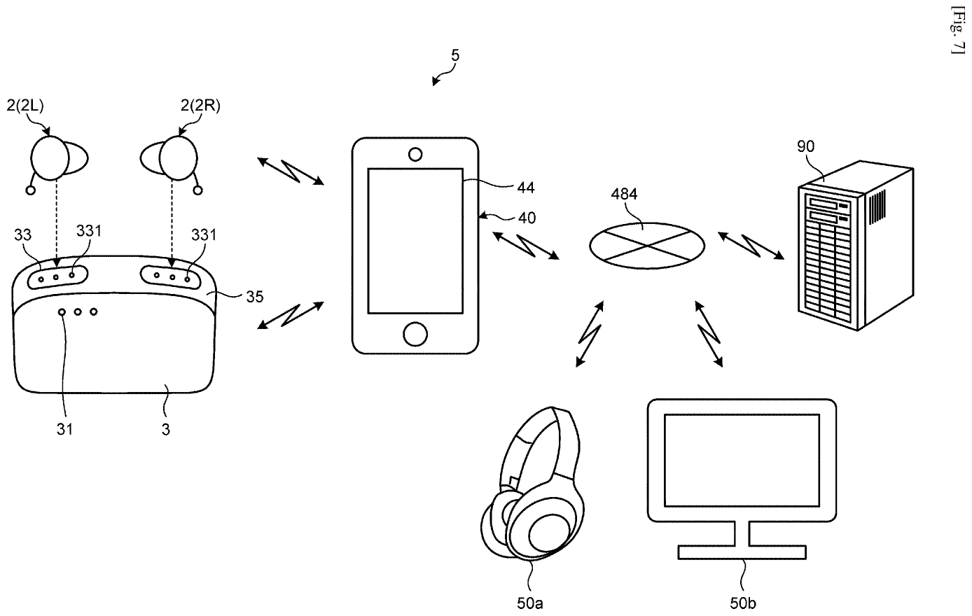

In the embodiments of the present disclosure created by the present inventors, various sound reproduction apparatuses 50 as illustrated in FIG. 6 can be adjusted according to the auditory characteristics of the user based on fitting data for the user to use the hearing aid 2. In the present embodiment, since parameters according to the performance of each of the sound reproduction apparatuses 50 can be generated, the user can use various sound reproduction apparatuses 50 without performing complicated adjustments. For example, a hearing aid system 5 according to an embodiment of the present disclosure as illustrated in FIG. 6 includes the hearing aid 2, the information processing terminal 40 including a smartphone or the like capable of communicating with the hearing aid 2, servers 90d, 90e, and 90f, and various sound reproduction apparatuses 50, for example. The apparatuses included in the hearing aid system 5 according to the present embodiment are connected to a communication network 484, that is, can cooperate with the apparatuses via a cloud. The sound reproduction apparatuses 50 can include audio equipment, a television device, a headphone speaker, a smartphone, a PC, a game device, and the like. In the present embodiment, the server 90d stores a plurality of pieces of fitting data for a plurality of users to use the hearing aid 2. The server 90f stores the device information of the sound reproduction apparatus 50, automatically generates parameters corresponding to the auditory characteristics of the user using the fitting data from the server 90d and the device information of the sound reproduction apparatus 50, and transmits the parameters to the sound reproduction apparatus 50 or the like. Therefore, in the present embodiment, various sound reproduction apparatuses 50 can perform hearing aid processing on the contents distributed from the server 90e according to the auditory characteristics of the user based on the generated parameters, and output the contents. That is, according to the present embodiment, the use of the hearing aid system 5 as illustrated in FIG. 6 makes it possible to easily adjust various sound reproduction apparatuses 50 according to the auditory characteristics of the user. The server 90e can further store a plurality of pieces of content data distributed, receive parameters corresponding to the auditory characteristics of the user generated by the server 90f, and distribute the parameters to the sound reproduction apparatus 50 together with the content data. In the present embodiment, the server 90e is not limited to the above-described configuration. The server 90e may perform the hearing aid processing on the content data so as to output sounds according to the auditory characteristics of the user using the fitting data from the server 90d and the device information of the sound reproduction apparatus 50 from the server 90f. The server 90e may transmit the content data having undergone the hearing aid processing to the sound reproduction apparatus 50 or the like. Even in this case, various sound reproduction apparatuses 50 can output the contents distributed from the server 90e in accordance with the auditory characteristics of the user. Hereinafter, details of embodiments of the present disclosure created by the present inventors will be described in sequence.

### 3. First Embodiment

### 3.1 Hearing Aid System

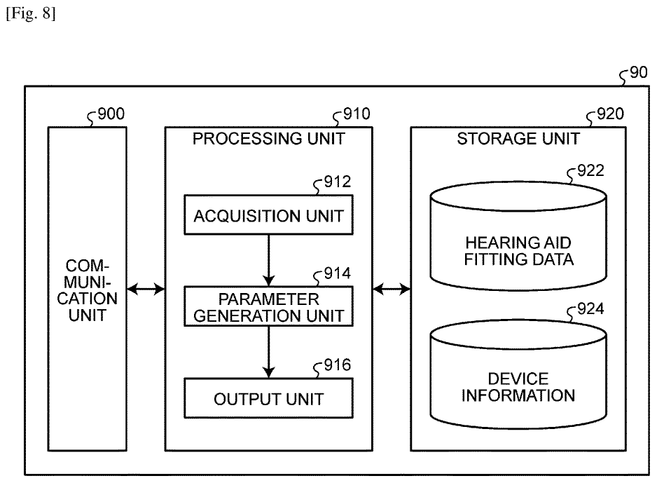

First, a hearing aid system (information processing system) 5 according to the present embodiment will be described with reference to FIG. 7. FIG. 7 is a diagram illustrating a schematic configuration of the hearing aid system 5 according to the present embodiment.

As illustrated in FIG. 7, the hearing aid system 5 according to the present embodiment includes a hearing aid 2, a charger 3 that houses the hearing aid 2 and electrically charges the hearing aid 2, and an information processing terminal 40 including a smartphone or the like capable of communicating with at least one of the hearing aid 2 and the charger 3. The hearing aid system 5 further includes various sound reproduction apparatuses 50a and 50b such as a television device and a headphone speaker, and a server (information processing apparatus) 90. Specifically, the information processing terminal 40, the sound reproduction apparatuses (auditory devices) 50, and the server 90 are connected to a communication network 484 via a base station or the like (for example, a base station of a mobile phone, an access point of a wireless local area network (LAN), and the like) which is not illustrated. As a wireless communication method used in the communication network 484, any method such as WiFi (registered trademark) or Bluetooth (registered trademark) can be applied, for example. However, it is desirable to use a communication method capable of maintaining a stable operation.

Hereinafter, an outline of each apparatus included in the hearing aid system 5 according to the present embodiment will be described. However, since the hearing aid 2, the charger 3, and the information processing terminal 40 are similar to the apparatuses included in the hearing aid system 1 described with reference to FIGS. 1 to 3, description of these apparatuses is omitted here, and only the sound reproduction apparatus 50 and the server 90 will be described.

### (Sound Reproduction Apparatus 50)

The sound reproduction apparatus 50 is an apparatus capable of reproducing sounds for the user, and specifically, is a speaker, an earphone speaker, a headphone speaker, a television device, an audio device, a smartphone (information processing terminal), or the like, for example. A detailed configuration of the sound reproduction apparatus 50 will be described later.

### (Server 90)

The server 90 includes a computer or the like, for example. For example, the server 90 generates parameters according to the present embodiment and transmits the parameters to the sound reproduction apparatus 50 or the information processing terminal 40. A detailed configuration of the server 90 will be described later.

In the present embodiment, the hearing aid system 5 is not limited to the configuration illustrated in FIG. 7.

### 3.2 Server

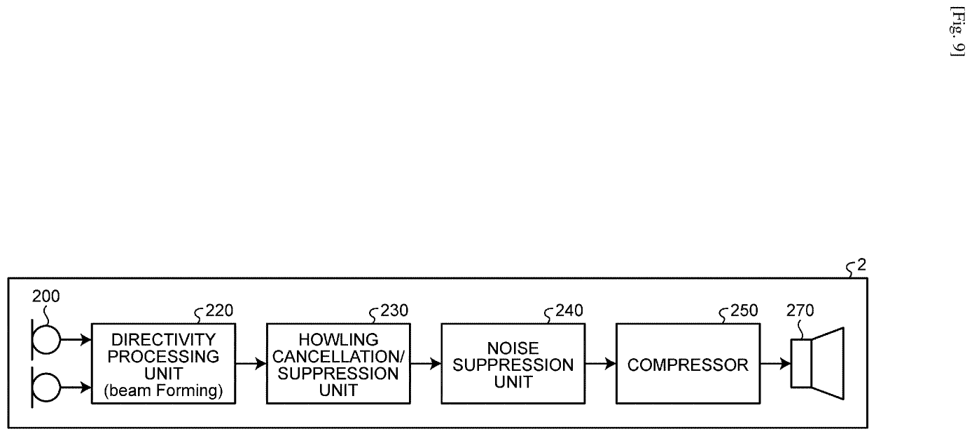

Next, a detailed configuration of the server 90 according to the present embodiment will be described with reference to FIG. 8. FIG. 8 is a block diagram for describing functional blocks of the server 90 according to the present embodiment. As illustrated in FIG. 8, the server 90 mainly includes a communication unit (transmission unit) 900, a processing unit 910, and a storage unit 920. Hereinafter, the functional blocks of the server 90 will be sequentially described in detail.

### (Communication Unit 900)

The communication unit 900 communicates with the sound reproduction apparatus 50, the information processing terminal 40, and the like via the communication network 484. In other words, the communication unit 900 can be said to be a communication interface having a function of transmitting and receiving data. The communication unit 900 is implemented by a communication device such as a transmission/reception circuit or a port, for example.

### (Processing Unit 910)

The processing unit 910 uses fitting data 922 for the user to use the hearing aid 2 and device information 924 of the sound reproduction apparatus 50 to generate parameters for acoustic processing in the sound reproduction apparatus 50. In the present embodiment, the processing unit 910 automatically or semi-automatically generates parameters for controlling the sound reproduction apparatus 50 suitable for the auditory characteristics of the user, using the fitting data 922 acquired by the user's fitting at the time of purchase and use of the hearing aid 2. Specifically, the processing unit 910 is implemented by hardware such as a central processing unit (CPU), a read only memory (ROM), and a random access memory (RAM).

More specifically, as illustrated in FIG. 8, the processing unit 910 mainly includes an acquisition unit (information acquisition unit) 912, a parameter generation unit 914, and an output unit 916. Hereinafter, details of each functional unit included in the processing unit 910 will be sequentially described.

The acquisition unit 912 acquires user identification information for identifying the user and device identification information for identifying the sound output apparatus (auditory device) other than the hearing aid owned by the user, which are transmitted from the information processing terminal 40 of the user according to the user's operation. The acquisition unit 912 further outputs the acquired information to the parameter generation unit 914 described later.

Based on the user identification information from the acquisition unit 912, the parameter generation unit 914 extracts the fitting data 922 of the user associated with the user identification information from the storage unit 920 described later. The parameter generation unit 914 extracts the device information 924 of the sound reproduction apparatus 50 associated with the device identification information from the storage unit 920 described later, based on the device identification information from the acquisition unit 912. Details of these pieces of information will be described later.

The parameter generation unit 914 generates parameters for acoustic processing in the sound reproduction apparatus 50 according to the auditory characteristics of the user based on the fitting data 922 and the device information 924, and outputs the parameters to the output unit 916 described later. Details of the generation of the parameters by the parameter generation unit 914 will be described later.

The output unit 916 transmits the parameters from the parameter generation unit 914 to the sound reproduction apparatus 50 or the information processing terminal 40 capable of controlling the sound reproduction apparatus 50 via the communication unit 900 described above.

### (Storage Unit 920)

The storage unit 920 stores programs, information, and the like for the above-described processing unit 910 to execute various types of processing, information obtained by the processing, and the like. The storage unit (fitting data storage unit) 920 further stores the fitting data 922 for a plurality of users to use the hearing aid 2. The storage unit (device information storage unit) 920 stores the device information 924 and the like. The storage unit 920 is implemented by a magnetic recording medium such as a hard disk (HD), for example. The storage unit 920 may be provided in a different apparatus on the hearing aid system 5 for each piece of information.

Specifically, examples of the fitting data 922 includes user identification information for identifying the user, attribute information of the user (gender, country of residence, and the like), functional configuration information of the hearing aid 2 (noise suppression, directivity processing, howling processing, multiband compressor, and the like), noise suppression parameters used in noise suppression, a threshold ratio (knee point and threshold) of a multiband compressor, frequency characteristic parameters, an audiogram (user's hearing measurement result), a fitting adjustment formula used for calculation of parameters (for example, NAL-NL, DSL, and the like), and information on a user's auditory characteristic model obtained by machine learning.

Specifically, examples of the device information 924 includes device identification information (manufacturer name, model number, etc.) for identifying each sound reproduction apparatus 50, and information such as functional configuration information (noise suppression, directivity processing, howling processing, multiband compressor, and the like), performance information, control parameters, and the like of each sound reproduction apparatus 50.

In the present embodiment, the server 90 is not limited to the configuration illustrated in FIG. 8.

### 3.3 Hearing Aid

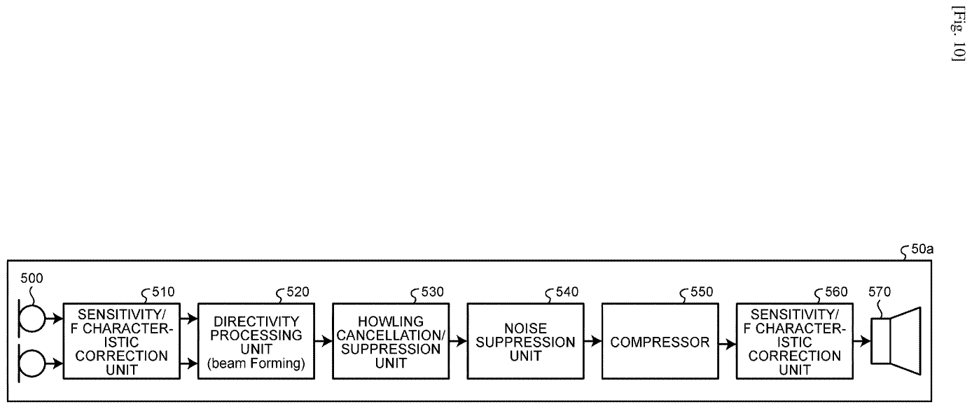

Next, details of main parts of the hearing aid 2 according to the present embodiment, that is, functional units related to acoustic processing will be described with reference to FIG. 9. FIG. 9 is a block diagram for describing functional blocks of the hearing aid 2 according to the present embodiment.

As illustrated in FIG. 9, the hearing aid 2 mainly includes a sound collection unit 200, a directivity processing unit 220, a howling cancellation/suppression unit 230, a noise suppression unit 240, a compressor 250, and an output unit 270. The directivity processing unit 220, the howling cancellation/suppression unit 230, the noise suppression unit 240, and the compressor 250 are functional units that perform acoustic processing, and can be constituted by a processor having hardware such as various memories and a digital signal processor (DSP). Hereinafter, the functional blocks of the hearing aid 2 will be sequentially described in detail.

### (Sound Collection Unit 200)

The sound collection unit 200 can collect environmental sounds around the user and output a sound signal to the directivity processing unit 220 described later. The sound collection unit 200 is implemented by a microphone or the like, for example. The sound collection unit 200 may include two or more sound collection units that collect environmental sounds around the user, and may further include a sound collection unit that collects sounds in the inner region of the user's ear canal.

### (Directivity Processing Unit 220)

The directivity processing unit 220 can identify the direction of the sound source based on level or time differences among the sounds collected by the two or more sound collection units 200, and perform acoustic processing to emphasize the sound from the front of the user, for example. The hearing aid 2 may not be provided with the directivity processing unit 220.

### (Howling Cancellation/Suppression Unit 230)

The howling cancellation/suppression unit 230 can perform acoustic processing to suppress howling and reverberation generated when a part of the sound output from the hearing aid 2 is collected again by the sound collection unit 200 of the hearing aid 2. The howling cancellation/suppression unit 230 outputs the sound signal having undergone the acoustic processing to the noise suppression unit 240 described later.

### (Noise Suppression Unit 240)

The noise suppression unit 240 performs acoustic processing to suppress or cancel noise included in the sound signal, and outputs the processed sound signal to the compressor 250 described later. At this time, the noise suppression unit 240 performs acoustic processing based on parameters (fitting parameters) set according to the auditory characteristics of the user. The noise suppression unit 240 may perform filtering processing or the like to separate the sound in each predetermined frequency band.

### (Compressor 250)

The compressor 250 can perform acoustic processing on a sound signal to reduce a dynamic range of the acoustic signal to a predetermined range in each predetermined frequency band, and output the sound signal to the output unit 270 described later. At this time, the compressor 250 performs acoustic processing based on parameters (fitting parameters) set according to auditory characteristics of the user. The compressor 250 may be constituted by an equalizer instead of the compressor.

### (Output Unit 270)

The output unit 270 is a device for outputting sounds having undergone the acoustic processing to the user, and is implemented by a speaker or the like, for example.

In the present embodiment, the hearing aid 2 is not limited to the configuration illustrated in FIG. 9.

### 3.4 Sound Reproduction Apparatus

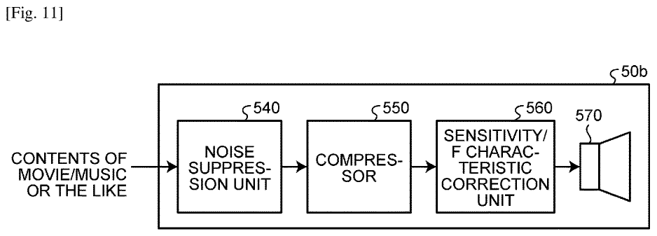

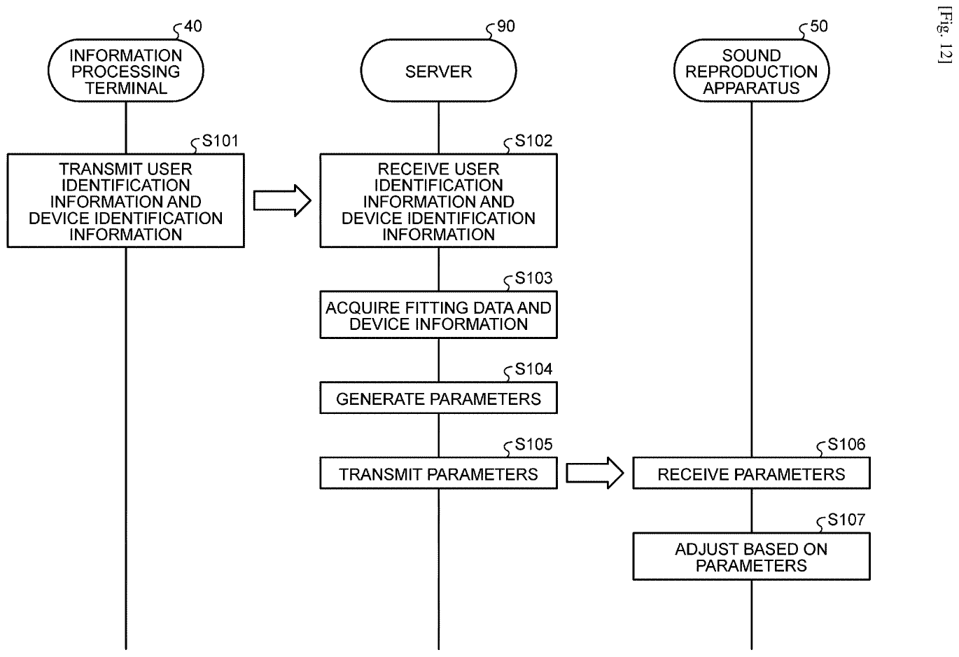

Next, the main parts of the sound reproduction apparatus 50 according to the embodiment, that is, the functional units related to the acoustic processing will be described in detail with reference to FIGS. 10 and 11. FIG. 10 is a block diagram for describing functional blocks of the sound reproduction apparatus 50a according to the present embodiment, and FIG. 11 is a block diagram for describing functional blocks of the sound reproduction apparatus 50b according to the present embodiment.

As illustrated in FIGS. 10 and 11, the sound reproduction apparatus 50 mainly includes a sound collection unit 500, sensitivity/frequency (F) characteristic correction units 510 and 560, a directivity processing unit 520, a howling cancellation/suppression unit 530, a noise suppression unit 540, a compressor 550, and an output unit 570, for example. The sensitivity/F characteristic correction units 510 and 560, the directivity processing unit 520, the howling cancellation/suppression unit 530, the noise suppression unit 540, and the compressor 550 are functional units that perform acoustic processing, and can be configured using a processor having hardware such as various memories and DSPs, for example. Hereinafter, the functional blocks of the sound reproduction apparatus 50 will be sequentially described in detail.

### (Sound Collection Unit 500)

The sound collection unit 500 can collect environmental sounds around the user and output a sound signal to the sensitivity/F characteristic correction unit 510 described later. The sound collection unit 500 is implemented by a microphone or the like, for example. The sound collection unit 500 may include two or more sound collection units that collect environmental sounds around the user, and may further include a sound collection unit that collects sounds in the inner region of the user's ear canal. Since the sound reproduction apparatus 50a illustrated in FIG. 10 includes the sound collection unit 500 and thus can accurately cancel noise using the sounds collected by the sound collection unit 500. In the sound reproduction apparatus 50, the sound collection unit 500 may not be provided as in the sound reproduction apparatus 50b illustrated in FIG. 11.

### (Sensitivity/F Characteristic Correction Unit 510 and 560)

The sensitivity/F characteristic correction unit 510 can perform acoustic processing to correct the sensitivity and frequency characteristics of the sound collection unit 500. Therefore, if the sound collection unit 500 is not provided as in the sound reproduction apparatus 50b illustrated in FIG. 11, the sensitivity/F characteristic correction unit 510 may not be provided. On the other hand, the sensitivity/F characteristic correction unit 560 can perform acoustic processing to correct the user's ear, sensitivity, and frequency characteristics in consideration of transmission characteristics of a transmission path from the output unit 570 described later to the user's ear.

### (Directivity Processing Unit 520)

The directivity processing unit 520 can identify the direction of the sound source based on level or time differences among the sounds collected by the two or more sound collection units 500, and perform acoustic processing to emphasize the sound from the front of the user, for example. If the sound collection unit 500 is not provided as in the sound reproduction apparatus 50b illustrated in FIG. 11, the directivity processing unit 520 may not be provided.

### (Howling Cancellation/Suppression Unit 530)

The howling cancellation/suppression unit 530 can perform acoustic processing to suppress howling and reverberation generated when a part of the sound output from the sound reproduction apparatus 50 is collected again by the sound collection unit 500 of the sound reproduction apparatus 50. If the sound collection unit 500 is not provided as in the sound reproduction apparatus 50b illustrated in FIG. 11, the howling cancellation/suppression unit 530 may not be provided.

### (Noise Suppression Unit 540)

The noise suppression unit 540 performs acoustic processing to suppress or cancel noise included in the sound signal, and outputs the processed sound signal to the compressor 550 described later. The noise suppression unit 540 may perform filtering processing or the like to separate the sound in each predetermined frequency band.

### (Compressor 550)

The compressor 550 can perform acoustic processing on a sound signal to reduce a dynamic range of the acoustic signal to a predetermined range in each predetermined frequency band, and output the sound signal to the output unit 570 described later. The compressor 550 may be constituted by an equalizer instead of the compressor.

### (Output Unit 570)

The output unit 570 is a device for outputting sounds having undergone the acoustic processing to the user, and is implemented by a speaker or the like, for example.

In the present embodiment, the sound reproduction apparatus 50 is not limited to the configuration illustrated in FIG. 10 or 11. For example, similarly to the hearing aid 2, the sound reproduction apparatus 50 may be equipped with an IMU (not illustrated) capable of acquiring information on the posture and motion of the user. The sound reproduction apparatus 50 may have a vibration sensor (not illustrated) instead of the IMU or together with the IMU. The sound reproduction apparatus 50 may include a positioning sensor (not illustrated) capable of acquiring information on the location of the user.

### 3.5 Processing Method

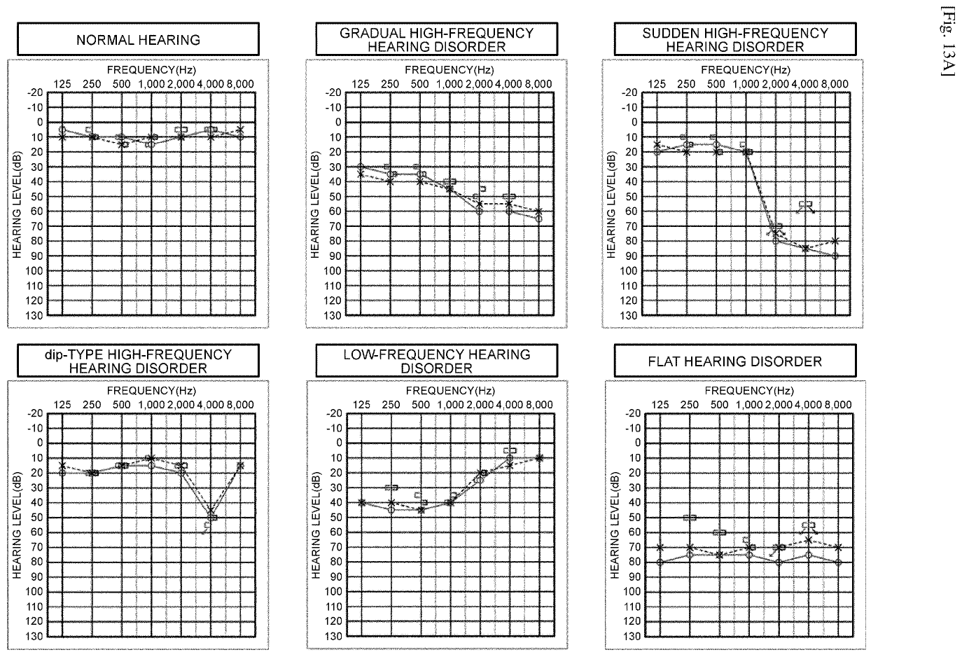

Next, a processing method performed by the hearing aid system (information processing system) 5 according to the present embodiment will be described with reference to FIG. 12. FIG. 12 is a sequence diagram of the processing method according to the present embodiment. As illustrated in FIG. 12, the processing method according to the present embodiment includes a plurality of steps from step S101 to step S107. Hereinafter, details of each step included in the information processing method according to the present embodiment will be described.

First, based on the user operation, the information processing terminal 40 transmits the user identification information for identifying the user and the device identification information for identifying the sound reproduction apparatus 50 to be used by the user to the server 90 (step S101). The server 90 receives the user identification information and the device identification information from the information processing terminal 40 (step S102).

Next, the server 90 acquires the fitting data 922 associated with the user identification information and the device information 924 associated with the device identification information from the storage unit 920, based on the user identification information and the device identification information received in step S102 (step S103). The server 90 generates parameters based on the fitting data 922 and the device information 924 acquired in step S103 (step S104). Details of the generation of the parameters will be described later. The server 90 transmits the generated parameters to the sound reproduction apparatus 50 or an information processing terminal capable of controlling the sound reproduction apparatus 50 (step S105).

The sound reproduction apparatus 50 or the information processing terminal capable of controlling the sound reproduction apparatus 50 receives the parameters from the server 90 (step S106). The sound reproduction apparatus 50 or the information processing terminal capable of controlling the sound reproduction apparatus 50 adjusts (performs acoustic processing on) the sound reproduction apparatus 50 based on the received parameters (step S107).

In the above description, the parameters are generated in the server 90. However, in the present embodiment, the present invention is not limited to only the server 90, and another device on the hearing aid system 5 may be used, or a plurality of devices may generate the parameters in cooperation. The adjustment based on the parameters may be performed only by the sound reproduction apparatus 50 such as a television device, or may be performed in cooperation by the information processing terminal 40 such as a smartphone and the sound reproduction apparatus 50 such as earphones.

### 3.6 Generation of Parameters

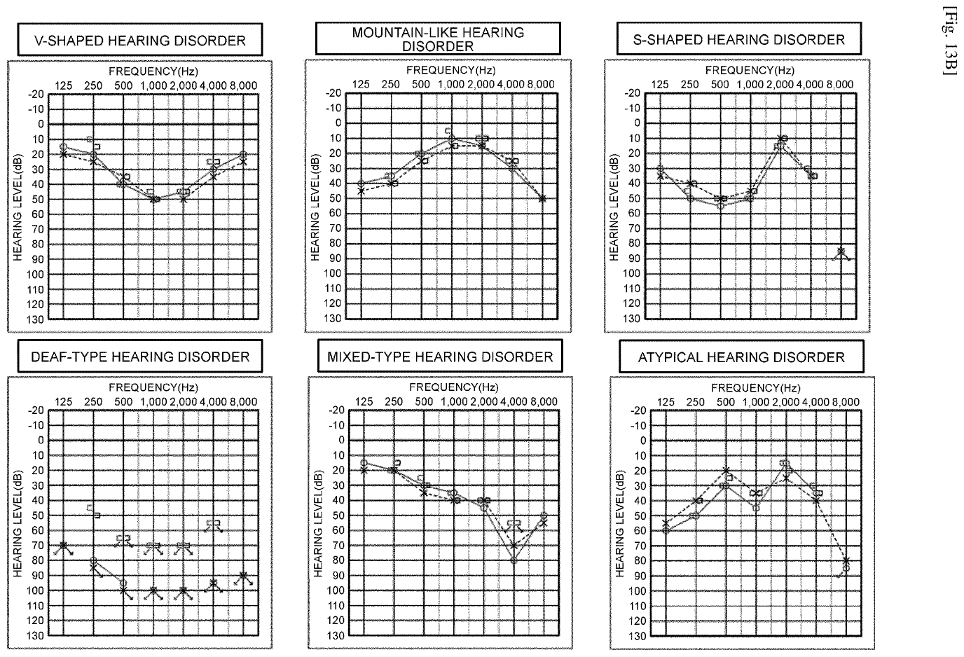

Next, generation of parameters according to the present embodiment will be described with reference to FIGS. 13A and 13B to 18. FIGS. 13A and 13B to 18 are explanatory diagrams for describing the processing method according to the present embodiment.

First, in the present embodiment, user identification information for identifying the user and device identification information for identifying the sound reproduction apparatus (auditory device) 50 other than the hearing aid owned by the user are transmitted to the server 90 from the information processing terminal 40 of the user according to the user's operation. The parameter generation unit 914 provided in the server 90 extracts the fitting data 922 of the user associated with the user identification information from the storage unit 920, based on the user identification information. The parameter generation unit 914 extracts the device information 924 of the sound reproduction apparatus 50 associated with the device identification information from the storage unit 920, based on the device identification information.

As described above, examples of the fitting data 922 includes the functional configuration information (noise suppression, directivity processing, howling processing, multiband compressor, and the like) of the hearing aid 2, the noise suppression parameters used in noise suppression, the threshold ratio (knee point and threshold) of the multiband compressor, the frequency characteristic parameters, the audiogram (user's hearing measurement result), the user's auditory characteristic model obtained by machine learning, and the like.

As described above, examples of the device information 924 includes device identification information (manufacturer name, model number, etc.) for identifying each sound reproduction apparatus 50, and information such as functional configuration information (noise suppression, directivity processing, howling processing, and multiband compressor), performance information, control parameters, and the like of each sound reproduction apparatus 50.

Therefore, the parameter generation unit 914 extracts functional units having common functions, based on the functional configuration information of the hearing aid 2 included in the fitting data 922 and the functional configuration information of the sound reproduction apparatus 50 included in the device information 924. Specifically, through a comparison between the plurality of functional units included in the hearing aid 2 as illustrated in FIG. 10 and the plurality of functional units included in the sound reproduction apparatus 50 illustrated in FIG. 11 or 12, the parameter generation unit 914 extracts functional units having common functions between the hearing aid 2 and the sound reproduction apparatus 50.

In recent years, if the sound reproduction apparatus 50 is headphones, earphones, or the like, the sound reproduction apparatus 50 is equipped with the sound collection unit 500 in order to cancel noise. Therefore, the sound reproduction apparatus 50 and the hearing aid 2 have very similar functional configurations. At the time of reproduction of a content, functional units that have the function of reproducing the sounds collected by the sound collection unit 500 in real time (for example, the directivity processing unit 520 and the howling cancellation/suppression unit 530) are not used in the sound reproduction apparatus 50. On the other hand, other functional units (for example, the noise suppression unit 540 and the compressor 550) are used in the sound reproduction apparatus 50. As can be seen from FIG. 10, the hearing aid 2 also includes functional units having similar functions (for example, the noise suppression unit 240 and the compressor 250). Therefore, in the present embodiment, it is assumed that the control parameters for the common functional units of the hearing aid 2 can be applied to the common functional units of the sound reproduction apparatus 50 (for example, the noise suppression unit 540 and the compressor 550). In the present embodiment, the parameter generation unit 914 refers to the extracted functional units having common functions, and generates the control parameters for the common functional units of the sound reproduction apparatus 50, based on the control parameter of the common functional unit of the hearing aid 2.

Specifically, the parameter generation unit 914 generates noise suppression parameters to be used by the noise suppression unit 540 of the sound reproduction apparatus 50, based on the parameters for the noise suppression unit 240 of the hearing aid 2, for example. The parameter generation unit 914 also generates the threshold ratio of the compressor 550 of the sound reproduction apparatus 50, based on the parameters for the compressor 250 of the hearing aid 2, for example. The parameter generation unit 914 further generates parameters related to the frequency characteristics of the noise suppression unit 540 and the compressor 550 of the sound reproduction apparatus 50, based on the frequency characteristic parameters for the noise suppression unit 240 and the compressor 250, for example.

In detail, the desirable operations for noise suppression are almost in common between normal-hearing persons and hearing-impaired persons. It is basically considered that the less noise is, the better. Therefore, even if the processing band of the hearing aid 2 is narrower than the reproduction band of the sound reproduction apparatus 50 that is the transfer destination, it is unlikely that fine adjustments according to the auditory characteristics of the user are essential for the band that is not processed by the hearing aid 2. Therefore, in the present embodiment, if parameters of a band that is not processed by the hearing aid 2 are required in the sound reproduction apparatus 50 that is the transfer destination, the parameters of the sound reproduction apparatus 50 set in advance for normal-hearing persons are used as they are.

In addition, there is a trade-off between noise and sound quality in which sound quality is likely to deteriorate when noise suppression is enhanced, and noise increases when control focusing on sound quality is performed. Normally, noise suppression in the hearing aid 2 is often adjusted by a representative parameter indicating a value of intensity of noise suppression (suppression amount). If the noise suppression function of the sound reproduction apparatus 50 that is the transfer destination is superior to the noise suppression function of the hearing aid 2, that is, if the sound reproduction apparatus 50 can further suppress noise while maintaining high sound quality, there is a possibility that a suppression amount larger than the suppression amount in the noise suppression of the hearing aid 2 can be selected as a parameter for the sound reproduction apparatus 50.

Therefore, in the present embodiment, the server 90 suggests the suppression amount of the hearing aid 2 to the user as a default, and further suggests a suppression amount increased or decreased by a predetermined value from the default suppression amount (for example, a suppression amount of ±6 dB from the suppression amount of the hearing aid 2). In the present embodiment, the user may select a preferred suppression amount from the suggested suppression amounts (feedback). At this time, the server 90 may display a slider on the information processing terminal 40 or the like, and cause the sound reproduction apparatus 50 to output the sound having undergone noise suppression processing by the suppression amount according to the operation of the slider by the user, for example. In this way, the user can select a preferred suppression amount from discrete or continuous suppression amounts.

The parameters for the compressors 250 and 550 include values of a knee point and a threshold (threshold ratio) indicating a relationship between an input sound level and a target output sound level, and the parameters define desired operation for the user. Therefore, in the present embodiment, the control parameters for the compressor 250 of the hearing aid 2 are used as the control parameters for the compressor 550 of the sound reproduction apparatus 50. The parameters for the compressors 250 and 550 are determined according to auditory characteristics of an individual user. Therefore, if the processing band of the compressor 250 of the hearing aid 2 is narrower than the processing band of the compressor 550 of the sound reproduction apparatus 50 that is the transfer destination, the auditory characteristics of the user may be measured even for a frequency band exceeding the processing band of the hearing aid 2 at the time of fitting of the hearing aid 2, and the formula used in the fitting of the hearing aid 2 may be applied to the measurement result to determine the parameters for the compressor 550 of the sound reproduction apparatus 50 that is the transfer destination. That is, in the present embodiment, if the processing band of the common functional units of the hearing aid 2 is different from the processing band of the acoustic processing by the common functional units of the sound reproduction apparatus 50, the parameter generation unit 914 generates the control parameters for the processing band of the acoustic processing by the common functional units of the sound reproduction apparatus 50, based on the control parameters for the processing band of the common functional units of the hearing aid 2.

In the present embodiment, the parameter generation unit 914 may generate the parameters based on the audiogram of the user included in the fitting data. The audiogram is represented in graphs as illustrated in FIGS. 13A and 13B, and indicates the auditory characteristics of the user. The audiogram is measured by a self-recording audiometer (also called a Bekesytype audiometer), which is a hearing test only for air conduction sounds, and the presence or absence of conductive hearing loss can be predicted from the measurement results, for example. A feature of the self-recording audiometer is that two types of intermittent sound and continuous sound are used as the test sound sources. At the test by the self-recording audiometer, the subject continues to press the button while the test sound is heard, and continues to release the button while the test sound is not heard. The self-recording audiometer gradually decreases the intensity of the test sound while the subject presses the button, and gradually increases the intensity of the test sound while the subject releases the button. As a result, when the intensity of the test sound during the test by the self-recording audiometer is recorded, a sawtooth wave graph is observed. It is said that the results from the self-recording audiometer can be classified to predict the type of hearing loss of the subject.

Therefore, in the present embodiment, the parameter generation unit 914 may determine a parameter in a frequency band exceeding the processing band of the hearing aid 2, based on the shape of the audiogram of the user, for example. More specifically, the parameter generation unit 914 may determine the parameter based on values obtained by extrapolating the measured values in the audiogram, for example. The parameter generation unit 914 may determine the parameter based on values obtained from a slope obtained by further adjusting a slope (for example, halving a slope) obtained by extrapolating the measured values in the audiogram, for example. Alternatively, the parameter generation unit 914 may suggest a plurality of parameters obtained based on the shape of the user's audiogram to the user, and the user may select a desired parameter from the plurality of suggested parameters.

In the present embodiment, there may be a performance difference between the hearing aid 2 and the sound reproduction apparatus 50 that is the transfer destination, even though they include functional units having common functions. Therefore, in the present embodiment, the parameter generation unit 914 generates parameters by performing processing in consideration of such a performance difference.

For example, it is conceivable that the processing in the functional units of the sound reproduction apparatus 50 that is the transfer destination has the same qualitative roles as those of the functional units of the hearing aid 2, but has higher resolution than that of the hearing aid 2. For example, the sound reproduction apparatus 50 may finely divide a frequency band to be processed and perform a suitable process for each frequency band as compared with the hearing aid 2. This is because the sound reproduction apparatus 50 uses a processor having higher calculation performance than the hearing aid 2, and the restriction on power consumption is also loose. In the case of reproducing a content, an allowable input/output delay in the sound reproduction apparatus 50 is also larger than that in the case of reproducing the sounds collected by the sound collection unit 200 of the hearing aid 2 in real time. Therefore, in the sound reproduction apparatus 50, it is not necessary to perform processing with priority given to suppression of input/output delay. For example, since priority is given to suppressing the input/output delay in the compressor 250 of the hearing aid 2, the output sound may deviate from the target level range, which is too large or too small, or the sound quality may be deteriorated depending on the signal. On the other hand, in the sound reproduction apparatus 50 that is the transfer destination, it is not necessary to perform processing with priority given to suppression of the input/output delay, and thus the output sound and the sound quality are natural and reliably fall within the target level range. In the sound reproduction apparatus 50, sound quality degradation is smaller, the amount of noise that can be suppressed is large, and there are many types of noise that can be suppressed.

Therefore, in the present embodiment, if the resolution (granularity) of the control parameters are different between functional units having common functions, the parameter generation unit 914 generates the parameters such that the control parameters for the hearing aid 2 are the same in granularity as the control parameters for the sound reproduction apparatus 50. For example, in the sound reproduction apparatus 50, a frequency band to be processed is finely divided as compared with that in the hearing aid 2, and a suitable parameter is set in each frequency band. In such a case, it can be said that there is an independent parameter in each band. Therefore, if control is performed at a frequency between two adjacent bands with parameters having values significantly different from the parameters set for the bands, for example, the operation may change abruptly, and sounds that may make the user uncomfortable may be output. Therefore, in order to avoid such a sudden change, the parameter generation unit 914 generates the control parameters for the sound reproduction apparatus 50 by arranging the control parameters for the hearing aid 2 on the logarithmic frequency axis and interpolating between the control parameters, for example.

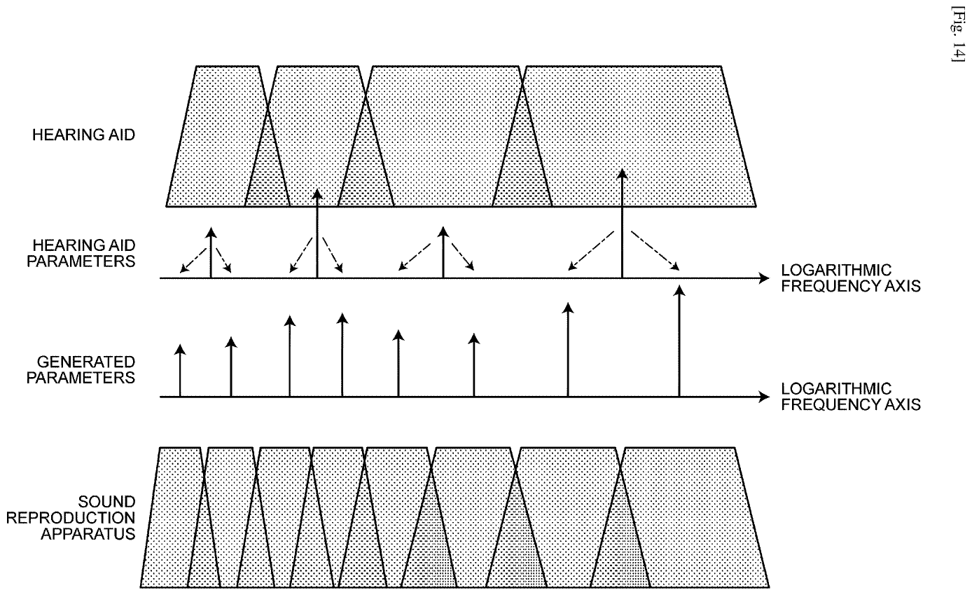

For example, description will be provided as to a case where, in the compressor 250 of the hearing aid 2, a frequency band to be processed is roughly divided as compared with that in the compressor 550 of the sound reproduction apparatus 50, and a suitable parameter is set in each frequency band, in other words, a case where the resolution (granularity) of control parameters for the hearing aid 2 are smaller than resolution (granularity) of control parameters for the sound reproduction apparatus 50. In this case, the number of parameters for the hearing aid 2 is smaller than the number of parameters for the sound reproduction apparatus 50. Therefore, as illustrated in the upper part of FIG. 14, the parameter generation unit 914 arranges the control parameters for the hearing aid 2 (indicated with arrows extending in the vertical direction in FIG. 14) on a logarithmic frequency axis, replicates the control parameters, and arranges the replicated control parameters on a logarithmic frequency axis. In this way, the parameter generation unit 914 generates a number of control parameters for the sound reproduction apparatus 50 (indicated with arrows extending in the vertical direction in FIG. 14) corresponding to the frequency resolution of the control parameters of the sound reproduction apparatus 50 as illustrated in the lower part of FIG. 14.

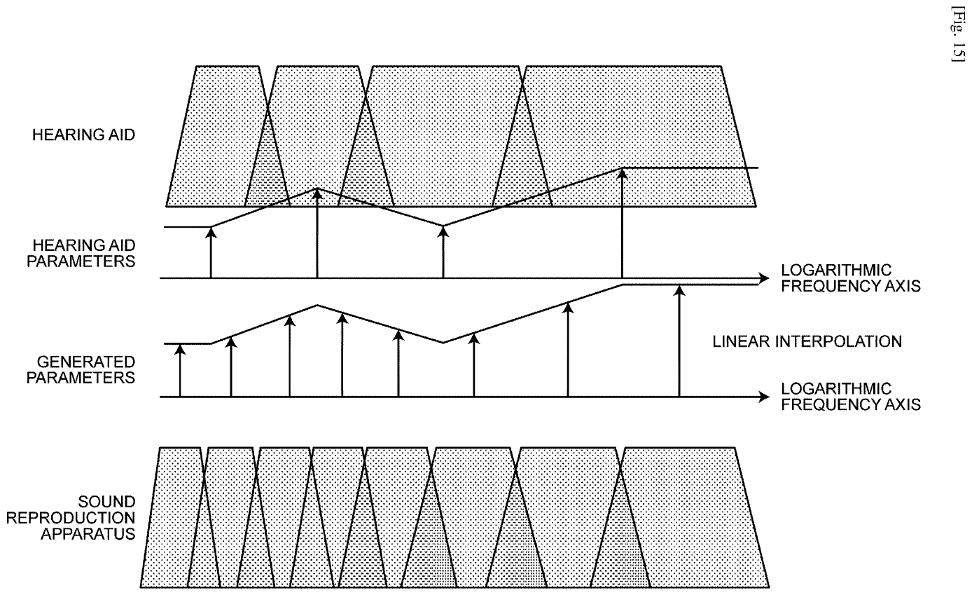

Description will be provided as to another example of a case where, in the compressor 250 of the hearing aid 2, a frequency band to be processed is roughly divided as compared with that in the compressor 550 of the sound reproduction apparatus 50, and a suitable parameter is set in each frequency band. As illustrated in the upper part of FIG. 15, the parameter generation unit 914 arranges the control parameters for the hearing aid 2 (indicated with arrows extending in the vertical direction in FIG. 15) on a logarithmic frequency axis, replicates the control parameters, and performs linear interpolation between the control parameters. The parameter generation unit 914 then generates, from the results of the linear complement, the control parameters for the sound reproduction apparatus 50 (indicated with arrows extending in the vertical direction in FIG. 15) as illustrated in the lower part of FIG. 15, according to the frequency band in the sound reproduction apparatus 50. In the present embodiment, the present invention is not limited to linear interpolation, and non-linear interpolation may be used.

The sound reproduction apparatus 50 that is the transfer destination may have almost used up the calculation resources for the functions only for implementation of functions other than the acoustic processing, and cannot spare resources sufficient for the acoustic processing. In this case, it is conceivable that the resolution (granularity) of the control parameters for the hearing aid 2 is larger than the resolution (granularity) of the control parameters for the sound reproduction apparatus 50. In the present embodiment, even in this case, the parameter generation unit 914 processes the control parameters for the hearing aid 2 and generates parameters so as to have the same granularity as the control parameters for the sound reproduction apparatus 50.

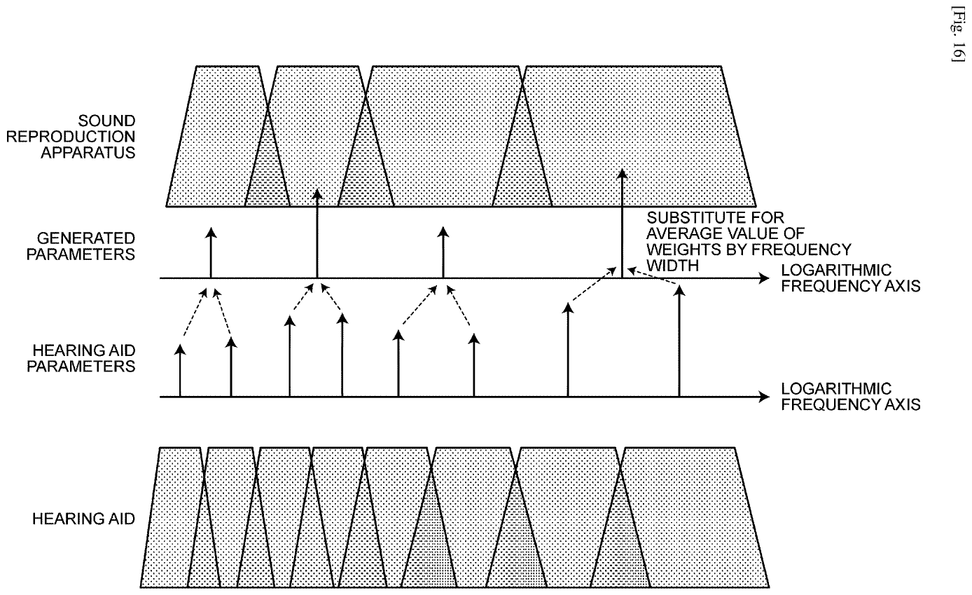

For example, in the compressor 250 of the hearing aid 2, a frequency band to be processed is finely divided as compared with that in the compressor 550 of the sound reproduction apparatus 50, and a suitable parameter is set in each frequency band. In this case, the number of parameters for the hearing aid 2 is larger than the number of parameters for the sound reproduction apparatus 50. Therefore, as illustrated in the lower part of FIG. 16, the parameter generation unit 914 arranges the control parameters for the hearing aid 2 (indicated with arrows extending in the vertical direction in FIG. 16) on a logarithmic frequency axis, calculates the average value of the adjacent control parameters, and arranges the average values on a logarithmic frequency axis. In this way, the parameter generation unit 914 generates a number of control parameters for the sound reproduction apparatus 50 (indicated with arrows extending in the vertical direction in FIG. 16) corresponding to the frequency resolution of the control parameters of the sound reproduction apparatus 50 as illustrated in the upper part of FIG. 16. At this time, the parameter generation unit 914 may calculate the average values after weighting the adjacent control parameters. In the example of FIG. 16, it can be said that, assuming that flat-level sounds are input in all bands, values are selected so as to have the minimum error in the logarithmic spectrum of output of the hearing aid 2 and output of the sound reproduction apparatus 50 that is the transfer destination.

In the present embodiment, if the resolution (granularity) of the control parameters is the same between the functional units having common functions, the parameter generation unit 914 generates the control parameters for the sound reproduction apparatus 50 based on the control parameters for the hearing aid 2.

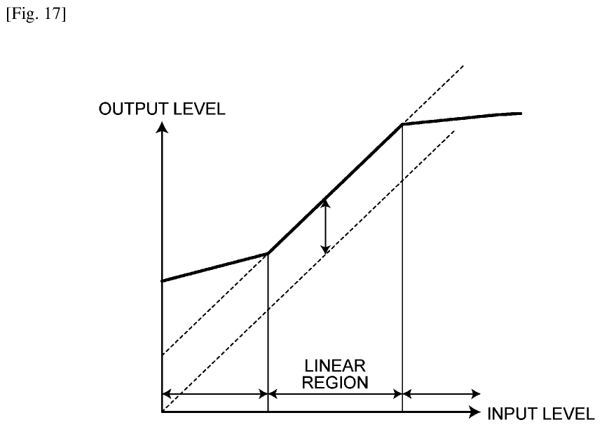

The functions of the sound reproduction apparatus 50 that is the transfer destination may be limited, the sound reproduction apparatus 50 may not include the noise suppression unit 540, or may include only an equalizer instead of the multiband compressor. In this case, in the present embodiment, in the relationship between the input sound level and the target output sound level in each processing band of the multiband compressor as illustrated in FIG. 17, for example, gains assumed in the linear region located at the center in the drawing may be used as gains (parameters) of the equalizer. Specifically, the parameter generation unit 914 generates parameters by applying an offset to a linear function indicating the linear region in the relationship between the input sound level and the target output sound level in each processing band, defined as the parameters for the compressor 250 of the hearing aid 2, according to the characteristic of the equalizer of the sound reproduction apparatus 50. More specifically, in the present embodiment, the equalizer of the sound reproduction apparatus 50 is controlled using the difference of a Y-intercept of the linear function indicating the offset amount.

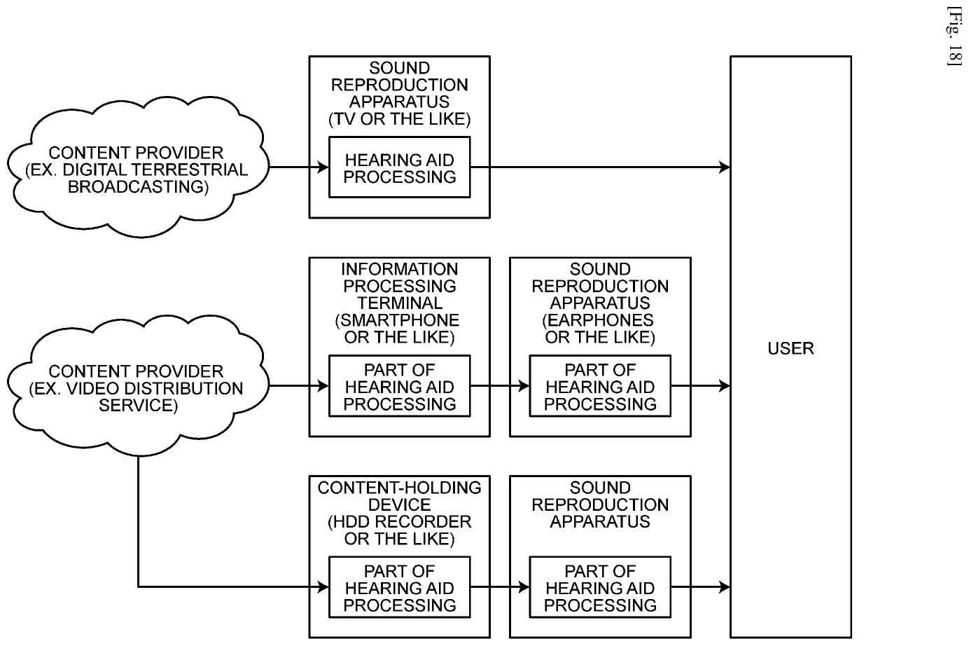

In the above description, all the acoustic processing (hearing aid processing) is performed in the sound reproduction apparatus 50. However, in the present embodiment, the apparatus that performs the acoustic processing is not limited to the sound reproduction apparatus 50. In the present embodiment, the acoustic processing (hearing aid processing) may be performed only by the sound reproduction apparatus 50 such as a television device, as illustrated in the upper part of FIG. 18, for example. In the present embodiment, the acoustic processing (hearing aid processing) may be performed in cooperation by the information processing terminal 40 such as a smartphone and the like and the sound reproduction apparatus 50 such as earphones, as illustrated in the middle part of FIG. 18, for example. In the present embodiment, the acoustic processing (hearing aid processing) may be performed in cooperation by a device such as a hard disk drive (HDD) recorder and the like and the sound reproduction apparatus 50, as illustrated in the lower part of FIG. 18, for example. In the present embodiment, although not illustrated in FIG. 18, all or a part of the acoustic processing (hearing aid processing) may be performed by the server 90.

In this case, the parameter generation unit 914 may select devices to perform the acoustic processing (hearing aid processing) according to a rule-based policy as described below. For example, as a rule, the same type of processing is not executed by a plurality of devices, but different devices are executed. For example, as a rule, devices to perform processing are selected such that the order of performing different types of processing is the same as the order of processing in the hearing aid 2 used by the user, or is not different from the order of processing in the hearing aid 2. If there are a plurality of devices as options, a higher-performance device is used. For example, since the device information 924 includes a label indicating the grade of processing performance of each device, the parameter generation unit 914 selects devices to perform the acoustic processing (hearing aid processing) based on such information.

A part of the fitting data 922 and the device information 924 and some of the generated parameters are information on privacy of the user. For example, the parameters related to the compressors 250 and 550 indirectly indicate the auditory characteristic of the user and thus are information on privacy of the user. Therefore, in the present embodiment, in order to protect privacy, it is preferable to exchange information between devices after performing predetermined encryption. In addition, exchange of the information related to privacy across countries may be prohibited. In this case, the parameter generation unit 914 may select devices to perform the acoustic processing (hearing aid processing) so as not to exchange information across countries.

As described above, in the present embodiment, the parameter generation unit 914 of the server 90 on the cloud can automatically generate the parameters according to the auditory characteristics of the user, by using the fitting data for the user to use the hearing aid 2 and the device information of the sound reproduction apparatus 50. In the present embodiment, the server 90 transmits the generated parameters to the sound reproduction apparatus 50, so that the user can easily use the sound reproduction apparatus 50 adjusted according to his/her auditory characteristics without specialized knowledge and performing complicated adjustments. As a result, according to the present embodiment, the user can enjoy high-quality sounds. In the present embodiment, since parameters according to the performance of each sound reproduction apparatus 50 can be generated based on the fitting data for the user to use the hearing aid 2, the user can use various sound reproduction apparatuses 50 without performing complicated adjustments.

It is also assumed that one user uses a plurality of sound reproduction apparatuses 50 that are the transfer destinations. In the present embodiment, in this case, a plurality of parameters may be generated instead of generating one parameter. In the present embodiment, the parameters for the sound reproduction apparatus 50 that is the transfer destination generated in the past may be stored in the server 90 and used next time.

In the present embodiment, it is assumed that the sound reproduction apparatus 50 is used by an individual. However, the present embodiment can also be used in a case where a plurality of the same sound reproduction apparatuses 50 is used but the auditory characteristics of a plurality of users are very close.

### 3.7 Modifications

For example, the operation expected for the acoustic processing differs depending on whether the voices of persons are the main content as in news programs or information programs, or the content other than the voices of a persons are the main content as in music programs. 52 Even in the case of listening to the voices of persons, appropriate acoustic processing varies depending on a situation such as whether the persons are in a conference room or a party venue.

The existing sound reproduction apparatus 50 has a function of preparing a mode dedicated to music (for example, noise suppression processing and the like that may adversely affect music reproduction is disabled, and the compressor 550 is controlled by parameters for music different from normal parameters) and switching between the modes manually or automatically. In recent years, since there has been a technology of performing analysis of environmental sounds around the user and recognizing a situation in which the user is present based on position information of the user, it is also possible to perform acoustic processing using results of such situation recognition.

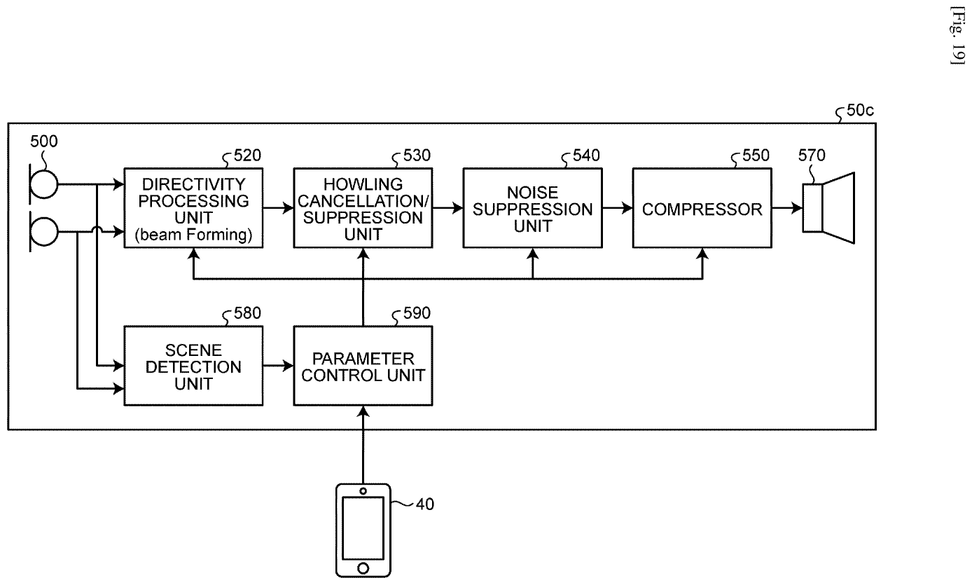

Therefore, as a modification of the present embodiment, a case where a sound reproduction apparatus 50 is provided with a scene detection unit (situation detection unit) 580 that recognizes a situation in which the user is present and a parameter control unit (adjustment unit) 590 that controls parameters in accordance with the situation and the mode of contents will be described with reference to FIG. 19. FIG. 19 is a block diagram for describing functional blocks of a sound reproduction apparatus 50c according to the modification of the present embodiment.

As illustrated in FIG. 19, the sound reproduction apparatus 50c includes a sound collection unit 500, a directivity processing unit 520, a howling cancellation/suppression unit 530, a noise suppression unit 540, a compressor 550, and an output unit 570, for example. The sound reproduction apparatus 50c further includes a scene detection unit 580 and a parameter control unit 590. Hereinafter, the functional blocks of the sound reproduction apparatus 50c will be described in detail. However, the sound collection unit 500, the directivity processing unit 520, the howling cancellation/suppression unit 530, the noise suppression unit 540, the compressor 550, and the output unit 570 are the same as those of the present embodiment, and thus, the description thereof will be omitted here. Only the scene detection unit 580 and the parameter control unit 590 will be described.

The scene detection unit 580 performs analysis of the environmental sounds around the user collected by the sound collection unit 500 to recognize a situation in which the user is present, whether the user is in a noisy place such as in a subway, whether the user is in a quiet place such as home, or the like, for example. The scene detection unit 580 outputs the results of recognition to the parameter control unit 590 described later. In the present modification, the scene detection unit 580 is not limited to recognizing the situation in which the user is present by sound analysis. For example, the scene detection unit 580 may recognize the situation in which the user is present, from information input by the user's operation or voice, meta information attached to the content distributed to the sound reproduction apparatus 50c, position information of the user from a positioning sensor (not illustrated) mounted in the sound reproduction apparatus 50c or the information processing terminal 40 used by the user, an image of the user captured by the information processing terminal 40 or an imaging device (not illustrated) around the user, sensing data from an IMU (not illustrated) or a vibration sensor (not illustrated) that is mounted in the sound reproduction apparatus 50c or the information processing terminal 40 used by the user to detect the motion and posture of the user, and the like.

The parameter control unit 590 adjusts parameters according to the recognition results from the scene detection unit 580, and controls each functional unit of the sound reproduction apparatus 50c. The parameter control unit 590 may adjust parameters according to a mode input by the user via the information processing terminal 40 and control each functional unit of the sound reproduction apparatus 50c. The parameter control unit 590 may recognize a suitable mode of a content distributed to the sound reproduction apparatus 50c, based on the meta information attached to the content, and adjust the parameters.

In the adjustment of the parameters according to the content, a model indicating a relationship between the content expected to be reproduced in the sound reproduction apparatus 50c and its suitable output spectrum is prepared in advance, for example. The parameter control unit 590 may adjust the parameters such that the output spectrum output from the sound reproduction apparatus 50c is similar to the output spectrum of the model.

In the present modification, the sound reproduction apparatus 50c is not limited to the configuration illustrated in FIG. 19.

### 3.8 Use of Reward Predictor

In the above description, the parameters for the sound reproduction apparatus 50 that is the transfer destination are generated by using the parameters for the hearing aid 2. However, the present embodiment is not limited to this, and for example, the parameters for the sound reproduction apparatus 50 may be generated using an intermediate product obtained in the process of fitting the hearing aid 2.

For example, two types of processed sounds or the like are output to the user, and feedback from the user on the two types of processed sounds or the like (for example, an answer to the question “which processed sound you like” or the like) is acquired. Repeating the output of the processed sounds and the acquisition of the feedback makes it possible to generate a model (auditory characteristic model) for estimating the user's preference based on the feedback using a reward predictor. In the hearing aid 2, fitting of the hearing aid 2 can be performed semi-automatically by such a model.

Therefore, in the present embodiment, if the model is obtained as the intermediate product in the fitting of the hearing aid 2, the parameter generation unit 914 generates the parameters for the sound reproduction apparatus 50 that is the transfer destination using the model included in the fitting data 922. Specifically, using the above model as a base, the parameter generation unit 914 outputs two types of processed sounds and the like to the user in the same manner as described above, acquires feedback from the user on the two types of processed sounds and the like, and generates the parameters for the sound reproduction apparatus 50 that is the transfer destination based on the feedback. In this case, since the model reflecting the user's preference has already been generated, it is possible to generate parameters suitable for the auditory characteristics of the user even with less feedback (alternatively, a small number of trials) than at the time of fitting.

In the present embodiment, the model may be in a fixed state, but may be updated by the result of feedback newly obtained in generating the parameters. In this way, in newly performing fitting or generating parameters, it is possible to perform fitting or generate parameters suitable for the auditory characteristics of the user even with less feedback (alternatively, a small number of trials).

In this case, if the feedback from the user obtained in the scene of fitting the hearing aid 2 and the feedback from the user obtained in the scene of generating the parameters for the sound reproduction apparatus 50 that is the transfer destination are treated with the same weight, suitable parameters may not be obtained. Therefore, weighting may be performed such that the feedback in the scene of generating parameters for the sound reproduction apparatus 50 is emphasized and is reflected more, for example.

If a plurality of users is viewing the same content such as a television program, the accuracy of generation of the parameters may be enhanced in light of the fact that the plurality of users is viewing the content. In this case, in the case of the same content, it is possible to generate parameters more suitable for the auditory characteristics of the users by using the reward predictor on the assumption that preferable parameters should be similar among the plurality of users.

### 4. Second Embodiment

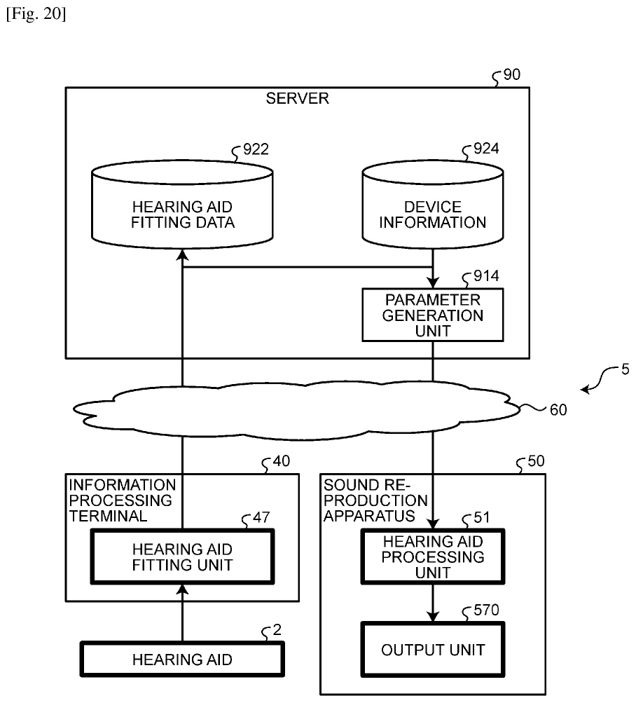

In the examples described so far, the parameter generation unit, the fitting data, the device information, and the like are included in the server 90. However, the present embodiment is not limited to this configuration. Variations of positions of the parameter generation unit, the fitting data, the device information, and the like will be described with reference to FIGS. 20 to 24. FIGS. 20 to 24 are diagrams illustrating schematic configurations of a hearing aid system 5 according to the present embodiment.

For example, referring to FIG. 20, the hearing aid system 5 includes a hearing aid 2, an information processing terminal 40, a sound reproduction apparatus 50, and a server 90. Specifically, the information processing terminal 40, the sound reproduction apparatus 50, and the server 90 are communicably connected to a communication network 60. Referring to FIG. 20, the server 90 includes a parameter generation unit 914, fitting data 922, and device information 924. The information processing terminal 40 includes a hearing aid fitting unit 47 that performs fitting of the hearing aid 2, and the sound reproduction apparatus 50 includes a hearing aid processing unit 51 that performs acoustic processing (hearing aid processing) and an output unit 570 that outputs sounds to the user.

For example, referring to FIG. 20, the information processing terminal 40 transmits the fitting data 922 of the hearing aid 2 to the server 90 together with user identification information for identifying the user who uses the hearing aid 2. The server 90 generates parameters using the fitting data 922 and the device information 924 stored in advance, based on the user identification information from the information processing terminal 40 and device identification information for identifying the sound reproduction apparatus 50 to be used for the user. The server 90 further transmits the generated parameters to the sound reproduction apparatus 50 corresponding to the device identification information. The sound reproduction apparatus 50 that has received the generated parameters performs acoustic processing (hearing aid processing) using the parameters and outputs sounds.

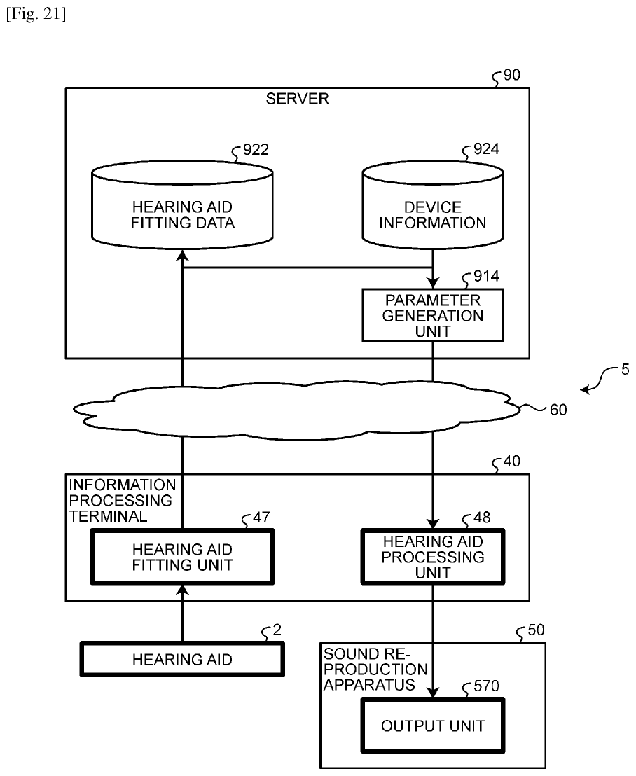

For example, referring to FIG. 21, the server 90 includes the parameter generation unit 914, the fitting data 922, and the device information 924. The information processing terminal 40 includes the hearing aid fitting unit 47 and a hearing aid processing unit 48 that performs acoustic processing (hearing aid processing), and the sound reproduction apparatus 50 includes the output unit 570. For example, referring to FIG. 21, the information processing terminal 40 that has received the parameters generated by the server 90 performs acoustic processing (hearing aid processing) using the parameters, and controls the sound reproduction apparatus 50 to output processed sounds.

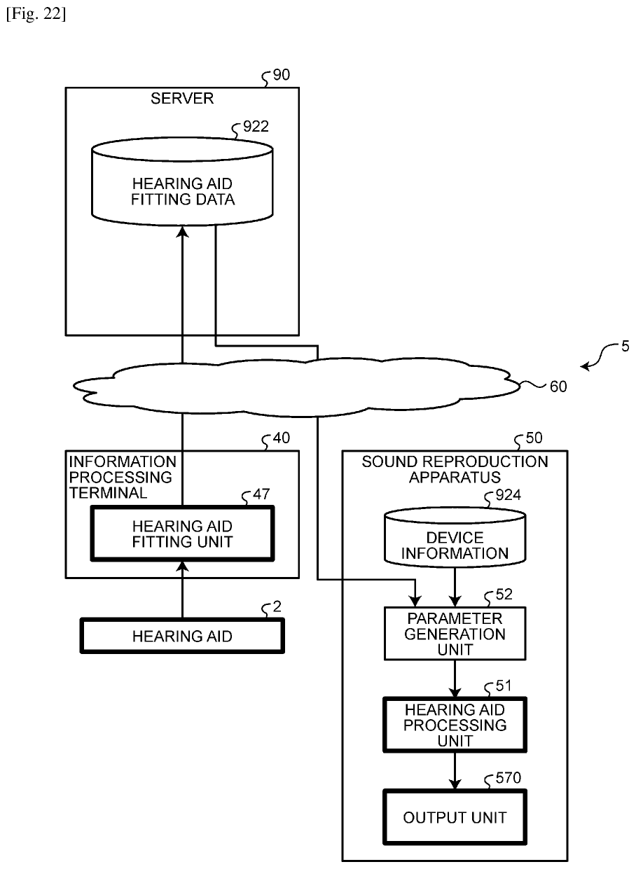

For example, referring to FIG. 22, the server 90 includes the fitting data 922. The sound reproduction apparatus 50 includes the parameter generation unit 52 and the device information 924. For example, referring to FIG. 22, the server 90 transmits the fitting data 922 to the sound reproduction apparatus 50 corresponding to the device identification information, based on the user identification information from the information processing terminal 40 and the device identification information for identifying the sound reproduction apparatus 50 to be used for the user. The sound reproduction apparatus 50 generates parameters by using the received fitting data 922 and device information 924, performs acoustic processing (hearing aid processing) by using the parameters, and outputs processed sounds.

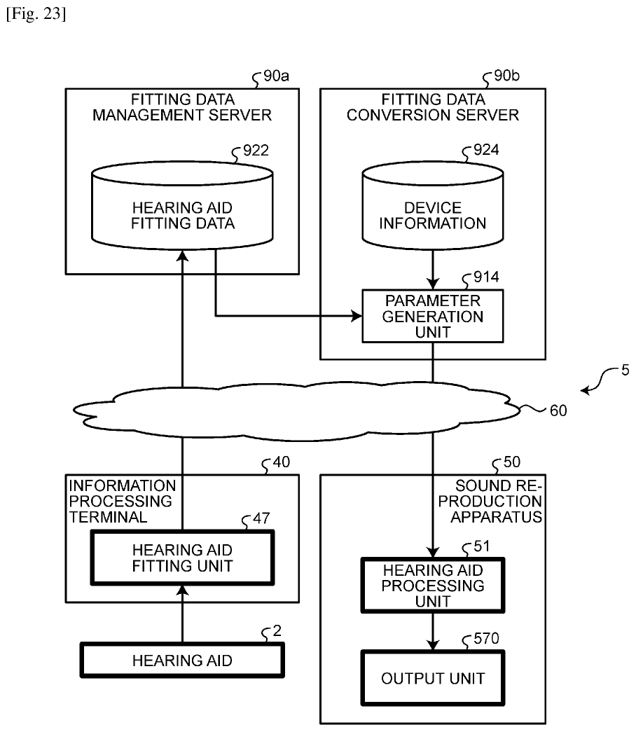

For example, referring to FIG. 23, a fitting data management server 90a includes the fitting data 922, and a fitting data conversion server 90b includes the parameter generation unit 914 and the device information 924.

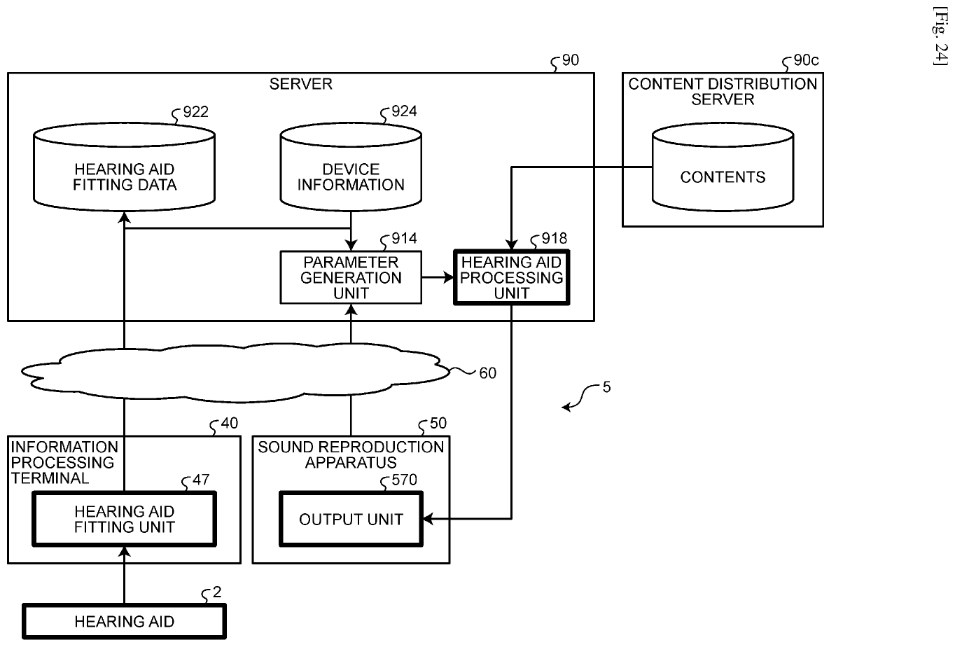

For example, referring to FIG. 24, the hearing aid system 5 further includes a content distribution server 90c. The content distribution server 90c stores a plurality of contents. Referring to FIG. 24, the server 90 includes the parameter generation unit 914, the fitting data 922, the device information 924, and a hearing aid processing unit 918 that performs acoustic processing (hearing aid processing). The hearing aid processing unit 918 performs acoustic processing (hearing aid processing) by using the meta information attached to the content from the content distribution server 90c together with the parameters from the parameter generation unit 914, and controls the sound reproduction apparatus 50 to output the processed sounds. In the present embodiment, the content distribution server 90c may include the parameter generation unit 914 and the hearing aid processing unit 918. In this case, the content distribution server 90c may perform the hearing aid processing on the content data using the fitting data and the device information stored in itself or stored in another server (not illustrated) such that the sounds are output according to the auditory characteristics of the user, and may directly transmit the content data having been undergone the hearing aid processing to the sound reproduction apparatus 50 or the like.

In the present embodiment, the hearing aid system 5 is not limited to the configurations illustrated in FIGS. 20 to 24.

### 5. Conclusion

As described above, in each embodiment of the present disclosure, the parameter generation unit 914 of the server 90 or the like can automatically generate the parameters according to the auditory characteristics of the user, by using the fitting data for the user to use the hearing aid 2 and the device information of the sound reproduction apparatus 50. In the present embodiment, the generated parameters are transmitted to the sound reproduction apparatus 50, so that the user can use the sound reproduction apparatus 50 adjusted according to his/her auditory characteristics without performing complicated adjustments. As a result, according to the present embodiment, the user can enjoy high-quality sounds. In the present embodiment, since parameters according to the performance of each sound reproduction apparatus 50 can be generated based on the fitting data for the user to use the hearing aid 2, the user can use various sound reproduction apparatuses 50 without performing complicated adjustments.

### 6. Example of Data Utilization

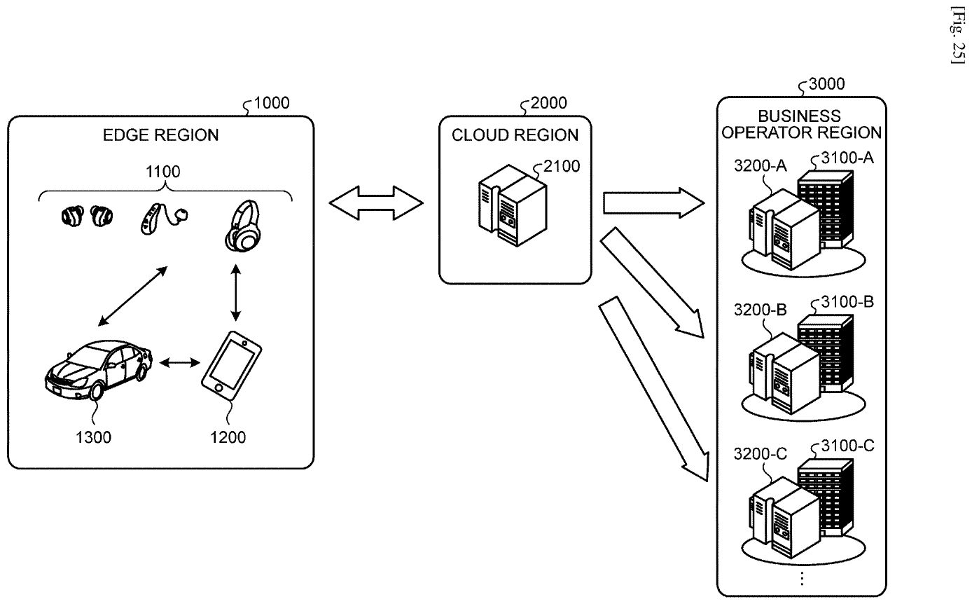

The data obtained in connection with use of the hearing aid 2 according to the embodiments of the present disclosure may be used in various ways. An example of data utilization will be described with reference to FIG. 25.

FIG. 25 is a diagram illustrating an example of data utilization. In the illustrated system, there are an edge region 1000, a cloud region 2000, and a business operator region 3000. Examples of elements in the edge region 1000 include a sound production device 1100, a peripheral device 1200, and a vehicle 1300. A server device 2100 is exemplified as an element in the cloud region 2000. Examples of elements in the business operator region 3000 include a business operator 3100 and a server device 3200.

The sound production device 1100 in the edge region 1000 is worn by the user or arranged near the user for use so as to emit sounds toward the user. Specific examples of the sound production device 1100 include earphones, a headset (headphone), and a hearing aid. More specifically, the sound production device 1100 can be the hearing aid 2.

The peripheral device 1200 and the vehicle 1300 in the edge region 1000 are devices used together with the sound production device 1100, and transmit signals of content viewing sounds, call sounds, and warning sounds to the sound production device 1100, for example. The sound production device 1100 outputs sounds corresponding to signals from the peripheral device 1200 or the vehicle 1300 to the user. A specific example of the peripheral device 1200 is a smartphone or the like. For example, the information processing terminal 40 described above with reference to FIG. 1 may be used as the peripheral device 1200.

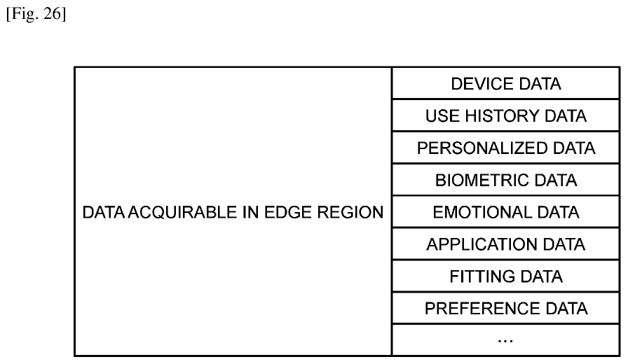

In the edge region 1000, various data on utilization of the sound production device 1100 may be obtained. A description will be given with reference to FIG. 26.

FIG. 26 is a diagram illustrating an example of data. Examples of data that can be acquired in the edge region 1000 include device data, use history data, personalized data, biometric data, emotional data, application data, fitting data, and preference data. The data may be understood as information, and they may be replaced as appropriate without a contradiction. Various known methods may be used to acquire the exemplified data.

The device data is data related to the sound production device 1100, and includes data on the type of the sound production device 1100, specifically, data indicating that the sound production device 1100 is earphones, headphones, a True Wireless Stereo (TWS), a hearing aid (CIC, ITE, RIC, or the like), or the like, for example.

The use history data is use history data of the sound production device 1100, and includes data on the music exposure amount, the continuous use time of the hearing aid, and the content listening history (the listening time and the like) and the like, for example. The use history data can be used for safe listening, hearing aid adaptation of TWS, replacement notification of an earwax intrusion preventive filter (not illustrated) provided in the hearing aid 2, and the like.

The personalized data is data related to the user of the sound production device 1100, and includes a head related transfer function (HRTF), ear canal characteristic, type of earwax, and the like of the user, for example. Data on hearing and the like may also be included in the personalized data.

The biometric data is biometric data of the user of the sound production device 1100, and includes data on perspiration, blood pressure, blood flow, heart rate, pulse, body temperature, electroencephalogram, respiration, myoelectric potential, and the like, for example.

The emotion data is data indicating the emotion of the user of the sound production device 1100, and includes data indicating comfort, discomfort, or the like, for example.

The application data is data used in various applications, and includes user attribute information data such as the position of the user of the sound production device 1100 (or the position of the sound production device 1100), schedule, age, gender, and the like, and further includes data on weather, atmospheric pressure, temperature, and the like, for example. For example, the position data can be used to search for the lost sound production device 1100 or to determine a timing for predicting clogging of the above-described earwax intrusion preventive filter.

The fitting data can include adjustment parameters for the hearing aid 2 used by the user, a hearing aid gain in each frequency band set based on a measurement result (audiogram) of hearing of the user, and the like, for example.

The preference data is data related to the preference of the user, and includes data on the preference for music to listen during driving, for example.

Data on a communication status, data on a charging status of the sound production device 1100, and the like may also be acquired. A part of processing in the edge region 1000 may be executed in the cloud region 2000 according to the band, the communication status, the charging status, and the like. Sharing the processing reduces the processing load in the edge region 1000.

Returning to FIG. 25, data as described above, for example, is acquired in the edge region 1000 and transmitted from the sound production device 1100, the peripheral device 1200, or the vehicle 1300 to the server device 2100 in the cloud region 2000. The server device 2100 stores (saves, accumulates, or the like) the received data.

The business operator 3100 in the business operator region 3000 uses the server device 3200 to acquire data from the server device 2100 in the cloud region 2000. The data become capable of being used by the business operator 3100.

There may be various business operators 3100. Specific examples of the business operator 3100 are a hearing aid store, a hearing aid manufacturer, a content production company, a distribution business operator providing a music streaming service, and the like, which are referred to and illustrated as a business operator 3100-A, a business operator 3100-B, and a business operator 3100-C for distinctions among them. The corresponding server devices 3200 are referred to and illustrated as a server device 3200-A, a server device 3200-B, and a server device 3200-C. Various types of data are provided to such various business operators 3100 to promote utilization of the data. The data provision to the business operators 3100 may be data provision by subscription, recurring, or the like, for example.

Data can also be provided from the cloud region 2000 to the edge region 1000. For example, if machine learning is required to implement processing in the edge region 1000, data for feedback, revision, and the like of learning data is prepared by an administrator or the like of the server device 2100 in the cloud region 2000. The prepared data is transmitted from the server device 2100 to the sound production device 1100, the peripheral device 1200, or the vehicle 1300 in the edge region 1000.

If a specific condition is satisfied in the edge region 1000, some incentive (benefit such as premium service) may be provided to the user. An example of the condition is a condition that at least some of the sound production device 1100, the peripheral device 1200, and the vehicle 1300 are devices provided by the same business operator. In the case of an incentive that can be electronically supplied (electronic coupon or the like), the incentive may be transmitted from the server device 2100 to the sound production device 1100, the peripheral device 1200, or the vehicle 1300.

### 7. Example of Cooperation with Other Devices

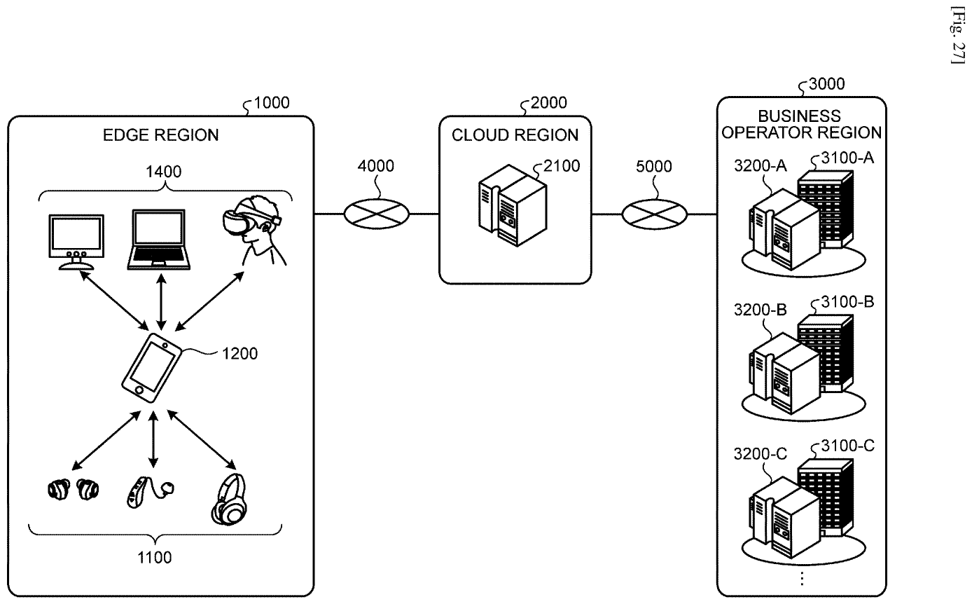

In the edge region 1000, the sound production device 1100 may cooperate with other devices using the peripheral device 1200 such as a smartphone as a hub, for example. An example will be described with reference to FIG. 27.

FIG. 27 is a diagram illustrating an example of cooperation with other devices. The edge region 1000, the cloud region 2000, and the business operator region 3000 are connected by a network 4000 and a network 5000. A smartphone is exemplified as the peripheral device 1200 in the edge region 1000, and other devices 1400 are exemplified as elements in the edge region 1000. Illustration of the vehicle 1300 (FIG. 25) is omitted.

The peripheral device 1200 is communicable with the sound production device 1100 and the other devices 1400. Although the communication method is not particularly limited, Bluetooth LDAC, Bluetooth LE Audio described above, or the like may be used, for example. Communication between the peripheral device 1200 and the other devices 1400 may be multicast communication. An example of the multicast communication is Auracast (registered trademark) or the like.

The other devices 1400 are used in cooperation with the sound production device 1100 via the peripheral device 1200. Specific examples of the other devices 1400 include a television (hereinafter, called TV), a personal computer (PC), a head mounted display (HMD), a robot, a smart speaker, a gaming device, and the like.

Also if the sound production device 1100, the peripheral device 1200, and the other devices 1400 satisfy a specific condition (for example, a condition that at least some thereof are provided by the same business operator), an incentive may be provided to the user.

The sound production device 1100 and the other devices 1400 can cooperate with the peripheral device 1200 as a hub. The cooperation may be made using various types of data stored in the server device 2100 in the cloud region 2000. For example, information such as fitting data, listening time, and hearing of the user is shared between the sound production device 1100 and the other devices 1400, whereby volume adjustment and the like of the devices are performed in cooperation. When the hearing aid 2 (HA) or a personal sound amplification products (PSAP) is worn, setting for the hearing aid 2 or the PSAP can be automatically performed on a TV, a PC, or the like. For example, when the user of the hearing aid 2 uses another device such as a TV or a PC, the settings of the other device may be automatically changed so as to be suitable for the user of the hearing aid, although the settings are usually made for normal-hearing persons. Whether the user is using the hearing aid 2 may be determined by automatically sending information indicating that the user has worn the hearing aid 2 (for example, wearing detection information) to a device such as a TV, a PC, or the like as a pairing destination of the hearing aid 2 when the user wears the hearing aid 2, or may be detected by using, as a trigger, approach of the user of the hearing aid to another target device such as a TV, a PC, or the like. It may be determined that the user is a hearing aid user by imaging the face of the user with a camera or the like provided in another device such as a TV, a PC, or the like, or by a method other than the above method. For example, the hearing aid 2 can function as earphones by establishing cooperation between a hearing aid 800, which is the sound production device 1100, and the other devices 1400. If the other devices 1400 include a microphone that collects surrounding sounds, earphones that are the sound production device 1100 can function like the hearing aid 2. In this case, the function of the hearing aid can be used in a style (appearance or the like) as if listening to music. The earphones/headphones and the hearing aid have many technically overlapping parts, and it is assumed that the demarcation between the earphones/headphones and the hearing aid will disappear in the future, and one device will have functions of both the earphones and the hearing aid. When the user's hearing is normal, the normal-hearing user can use the device as earphones/headphones to enjoy content listening experience, and when the user's hearing is lowered due to aging or the like, the device can function as a hearing aid by turning on the hearing aid function. Since the device as earphones can also be used as a hearing aid, continuous and long-term use of the device by the user can be expected from the viewpoint of appearance and design.

Data of the user's listening history may be shared. Prolonged listening can be a risk for future hearing loss. Notification or the like may be provided to the user so that the listening time does not become too long. For example, when the listening time exceeds a predetermined threshold, such a notification is provided (safe listening). The notification may be provided by any device in the edge region 1000.

At least some of the devices used in the edge region 1000 may be provided by different business operators. Information on device settings and the like of each business operator may be transmitted from the server device 3200 in the business operator region 3000 to the server device 2100 in the cloud region 2000 and stored in the server device 2100. Using such information enables cooperation between devices provided by different business operators.

### 8. Example of Application Transition

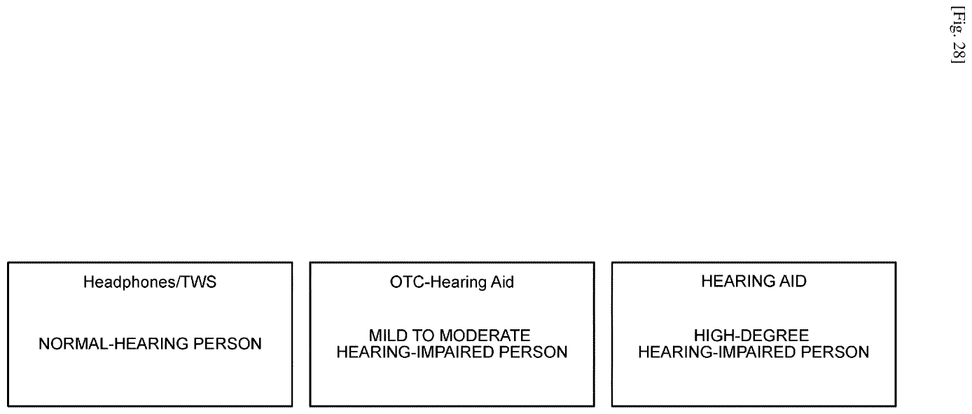

The application of the sound production device 1100 may transition according to various situations including the user's fitting data, listening time, hearing, and the like as described above. An example will be described with reference to FIG. 28.

FIG. 28 is a diagram illustrating an example of application transition. When the user has normal hearing, for example, while the user is a child and for a while after becoming an adult, the sound production device 1100 is used as headphones or earphones (headphones/TWS). In addition to the safe listening described above, adjustment of the equalizer, processing according to the user's behavior characteristics, current location, and external environment (for example, switching takes place between an optimal noise canceling mode in a scene in which the user is at a restaurant and an optimal noise canceling mode in a scene in which the user is on a vehicle), collection of listening music logs, and the like are performed. Communication between devices using Auracast is also utilized.

As the user's hearing declines, the hearing aid function of the sound production device 1100 begins to be utilized. For example, while the user is with mild to moderate hearing impairment, the sound production device 1100 is used as an over the counter hearing aid (OTC hearing aid). When the user has a high degree of hearing impairment, the sound production device 1100 is used as a hearing aid. The OTC hearing aid is a hearing aid that is sold at shops without expert intervention, and is easy to purchase without going through a hearing test or an expert such as an audiologist. A specific operation of the hearing aid such as fitting may be performed by the user himself/herself. While the sound production device 1100 is used as an OCT hearing aid or a hearing aid, hearing measurement is performed or the hearing aid function is turned on. For example, the function of transmission of an utterance flag in the above-described embodiment can also be used. Various types of information on hearing (hearing big data) are collected, fitting, sound environment adaptation, remote support, and the like are performed, and a transcription is performed.

### 9. Supplement

As described above, the favorable embodiments of the present disclosure have been described in detail with reference to the accompanying drawings, but the technical scope of the present disclosure is not limited to such examples. It is obvious that persons having ordinary knowledge in the technical field of the present disclosure can conceive various changes and alterations within the scope of the technical idea described in the claims, and it is naturally understood that these changes and alterations belong to the technical scope of the present disclosure.

In addition, the effects described in the present specification are merely illustrative or exemplary, and are not limited to those described in the present specification. That is, the technology according to the present disclosure can exhibit other effects apparent to those skilled in the art from the description of the present specification, in addition to or instead of the effects described above.

The present technology can also have the following configurations.

(1)

An information processing system comprising:
a fitting data storage unit configured to store fitting data for a user of a hearing aid to use the hearing aid;
a device information storage unit configured to store a plurality of pieces of device information related to a plurality of auditory devices;
a parameter generation unit configured to generate a parameter for acoustic processing in the auditory device according to an auditory characteristic of the user, based on the fitting data and the device information corresponding to the auditory device used by the user; and
a transmission unit configured to transmit the generated parameter to the auditory device or an information processing terminal capable of controlling the auditory device.
   (2)

The information processing system according to (1), wherein the plurality of auditory devices includes at least one device of a television device, an audio device, a speaker, an information processing terminal, a headphone speaker, and an earphone speaker.

(3)

The information processing system according to (1) or (2), wherein the device information includes device identification information for identifying the auditory device, functional configuration information of the auditory device, performance information of the auditory device, and information of a control parameter of the auditory device.

(4)

The information processing system according to any one of (1) to (3), wherein the fitting data includes information of at least one of a noise suppression parameter, a threshold ratio of a compressor, a frequency characteristic parameter, an audiogram, a fitting adjustment formula, and an auditory characteristic model.

(5)

The information processing system according to any one of (1) to (4), wherein the fitting data storage unit stores a plurality of pieces of fitting data for a plurality of users of the hearing aid to use the hearing aid.

(6)

The information processing system according to (5), further comprising an information acquisition unit configured to acquire user identification information for identifying the user and device identification information for identifying the auditory device possessed by the user, wherein
the parameter generation unit generates the parameter, based on the fitting data associated with the acquired user identification information and the device information associated with the acquired device identification information.
   (7)

The information processing system according to (6), wherein
the parameter generation unit:
compares a plurality of functional units of the hearing aid used by the user with a plurality of functional units of the auditory device used by the user, and extracts functional units having a common function, based on the device information associated with the acquired device identification information, and
generates a control parameter for acoustic processing in the common functional unit of the auditory device, based on a control parameter of the common functional unit of the hearing aid included in the fitting data.
   (8)

The information processing system according to (7), wherein the parameter generation unit generates at least one of a noise suppression parameter used by a noise suppression unit of the auditory device, a frequency characteristic parameter, and a threshold ratio used by a compressor of the auditory device.

(9)

The information processing system according to (7) or (8), wherein if a granularity of the control parameter of the common functional unit of the hearing aid is different from a granularity of the control parameter for the acoustic processing in the common functional unit of the auditory device, the parameter generation unit generates the control parameter for the acoustic processing in the common functional unit of the auditory device such that the granularity of the control parameter of the common functional unit of the hearing aid is the same as the granularity of the control parameter for the acoustic processing in the common functional unit of the auditory device.

(10)

The information processing system according to (9), wherein if the granularity of the control parameter of the common functional unit of the hearing aid is smaller than the granularity of the control parameter for the acoustic processing in the common functional unit of the auditory device, the parameter generation unit generates the control parameter for the acoustic processing in the common functional unit of the auditory device by duplicating a value included in the control parameter of the common functional unit of the hearing aid.

(11)

The information processing system according to (9), wherein if the granularity of the control parameter of the common functional unit of the hearing aid is smaller than the granularity of the control parameter for the acoustic processing in the common functional unit of the auditory device, the parameter generation unit generates the control parameter for the acoustic processing in the common functional unit of the auditory device by interpolating a value included in the control parameter of the common functional unit of the hearing aid.

(12)

The information processing system according to (9), wherein if the granularity of the control parameter of the common functional unit of the hearing aid is larger than the granularity of the control parameter for the acoustic processing in the common functional unit of the auditory device, the parameter generation unit generates the control parameter for the acoustic processing in the common functional unit of the auditory device by calculating an average value of a plurality of adjacent values included in the control parameter of the common functional unit of the hearing aid.

(13)

The information processing system according to (7) or (8), wherein if the granularity of the control parameter of the common functional unit of the hearing aid is identical to the granularity of the control parameter for the acoustic processing in the common functional unit of the auditory device, the parameter generation unit generates the control parameter for the acoustic processing in the common functional unit of the auditory device based on the control parameter of the common functional unit of the hearing aid.

(14)

The information processing system according to (7) or (8), wherein if a processing band of the common functional unit of the hearing aid is different from a processing band of the acoustic processing in the common functional unit of the auditory device, the parameter generation unit generates the control parameter for the acoustic processing in the common functional unit of the auditory device with respect to the processing band of the acoustic processing in the common functional unit of the auditory device, based on the control parameter of the processing band of the common functional unit of the hearing aid.

(15)

The information processing system according to any one of (1) to (8), wherein the parameter generation unit generates the parameter based on feedback from the user on a processed sound acoustically processed by the parameter generated previously.

(16)

The information processing system according to any one of (1) to (8), wherein the parameter generation unit generates the parameter based on an audiogram of the user included in the fitting data.

(17)

The information processing system according to any one of (1) to (8), wherein the parameter generation unit generates the parameter, based on an auditory characteristic model of the user obtained by machine learning that is included in the fitting data.

(18)

An auditory device that reproduces a sound of a content and outputs the sound to a user, wherein acoustic processing is controlled by a parameter corresponding to an auditory characteristic of the user, the parameter being generated based on fitting data for the user to use a hearing aid and device information on the auditory device.

(19)

The auditory device according to (18), comprising:
a situation detection unit configured to detect a situation of the user based on at least one of piece of information of information input by an operation or a voice of the user, sensing data from an inertial measurement unit that detects a motion of the user, sensing data from a vibration sensor, and position information of the user from a positioning sensor; and
an adjustment unit configured to adjust the parameter according to the detected situation.
   (20)

An information processing apparatus comprising:
a fitting data storage unit configured to store fitting data for a user of a hearing aid to use the hearing aid;
a device information storage unit configured to store a plurality of pieces of device information related to a plurality of auditory devices;
a parameter generation unit configured to generate a parameter for acoustic processing in the auditory device according to an auditory characteristic of the user, based on the fitting data and the device information corresponding to the auditory device used by the user; and
a transmission unit configured to transmit the generated parameter to the auditory device or an information processing terminal capable of controlling the auditory device.
   (21)

An information processing system, comprising:
circuitry configured to
acquire fitting data corresponding to a hearing aid;
acquire device information for an output device that at least outputs audio;
generate at least one audio processing parameter for the output device based on the fitting data and the device information; and
provide information to the output device to output audio based on the at least one audio processing parameter.
   (22)

The information processing system according to (21), wherein the circuitry is further configured to transmit, as the information, the at least one audio processing parameter to the output device.

(23)

The information processing system according to (21), wherein the circuitry is further configured to:
process audio based on the at least one audio processing parameter; and
transmit, as the information, the audio, after processing with the at least one audio processing parameter, to the output device for output.
   (24)

The information processing system according to any one of (21) to (23), further comprising a storage circuit configured to store fitting data for a plurality of users, wherein the circuitry is further configured to acquire fitting data for a user of the hearing aid from the storage circuit.

(25)

The information processing system according to (24), wherein the circuitry is further configured to:
receive input of user identification information corresponding to the user of the hearing aid, and
acquire the fitting data for the user of the hearing aid from the storage circuit based on the user identification information.
   (26)

The information processing system according to any one of (21) to (25), wherein the circuitry is further configured to:
compare functionality of the hearing aid with corresponding functionality of the output device, based on the fitting data and the device information, and
generate, based on the comparison, the at least one audio processing parameter for the output device.
   (27)

The information processing system according to (26), wherein the circuitry is further configured to:
compare at least one functional unit of the hearing aid with at least one corresponding functional unit of the output device based on functional configuration information of the hearing aid included in the fitting data and functional configuration information of the output device included in the device information, and
generate, based on a control parameter of the at least one functional unit of the hearing aid, the at least one audio processing parameter for the output device having a same resolution as a resolution of a control parameter of the at least one corresponding functional unit of the output device in a case that the control parameter of the at least one functional unit of the hearing aid and the control parameter of the at least one corresponding functional unit of the output device are of different resolutions.
   (28)

The information processing system according to (27), wherein the circuitry is further configured to duplicate a value included in the control parameter of the at least one functional unit of the hearing aid to generate the at least one audio processing parameter for the output device in a case that the control parameter of the at least one functional unit of the hearing aid has a smaller resolution than the control parameter of the at least one corresponding functional unit of the output device.

(29)

The information processing system according to (27), wherein the circuitry is further configured to interpolate at least some values of the control parameter of the at least one functional unit of the hearing aid to generate the at least one audio processing parameter for the output device in a case that the control parameter of the at least one functional unit of the hearing aid has a smaller resolution than the control parameter of the at least one corresponding functional unit of the output device.

(30)

The information processing system according to (27), wherein the circuitry is further configured to generate an average of at least some values included in the control parameter of the at least one functional unit of the hearing aid to generate the at least one audio processing parameter for the output device having a same resolution as the control parameter of the at least one corresponding functional unit of the output device in a case that the control parameter of the at least one functional unit of the hearing aid has a greater resolution than the control parameter of the at least one corresponding functional unit of the output device.

(31)

The information processing system according to (26), wherein the circuitry is further configured to generate the at least one audio processing parameter for the output device according to performance of the hearing aid for a specific range of input.

(32)

The information processing system according to any one of (21) to (31), wherein the fitting data includes at least an audiogram of a user of the hearing aid, and
the circuitry is further configured to generate the at least one audio processing parameter based on the audiogram and the device information.
   (33)

The information processing system according to any one of (21) to (32), wherein the fitting data includes at least one of noise suppression information of the hearing aid, directivity processing information of the hearing aid, compression information of the hearing aid, howling suppression information of the hearing aid, frequency characteristic information of the hearing aid, fitting adjustment information, and user auditory characteristic information.

(34)

The information processing system according to any one of (21) to (33), wherein the fitting data includes an auditory characteristic model of a user obtained by machine learning, and
the circuitry is further configured to generate the at least one audio processing parameter based on the auditory characteristic model of the user.
   (35)

The information processing system according to any one of (21) to (34), wherein the device information includes at least one of device identification information of the output device, noise suppression information of the output device, directivity processing information of the output device, howling suppression information of the output device, compression information of the output device, and control information of the output device.

(36)

The information processing system according to any one of (21) to (35), wherein the circuitry is further configured to output a plurality of audio processing parameters for user selection of at least a subset thereof.

(37)

The information processing system according to any one of (21) to (36), further comprising a server to be connected with the hearing aid and the output device through a network,
wherein the server includes the circuitry.
   (38)

The information processing system according to (37), further comprising a storage circuit configured to store fitting data for a plurality of users,
wherein the storage circuit and the server are connected through the network, and
the circuitry is further configured to acquire the fitting data for a user of the hearing aid from the storage circuit.
   (39)

The information processing system according to (22), wherein the circuitry is further configured to encrypt the at least one audio processing parameter before transmitting the at least one audio processing parameter to the output device.

(40)

The information processing system according to any one of (21) to (39), wherein the circuitry is further configured to generate a plurality of audio processing parameters for a plurality of different modes, the plurality of different modes include at least a mode for music reproduction and a mode for a spoken voice.

(41)

The information processing system according to (40), wherein, in the mode for a spoken voice, the circuitry is further configured to generate the at least one audio processing parameter based on a position of a user of the hearing aid.

(42)

An information processing method, comprising:
acquiring, with circuitry, fitting data corresponding to a hearing aid;
acquiring, with the circuitry, device information for an output device that at least outputs audio;
generating, with the circuitry, at least one audio processing parameter for the output device based on the fitting data and the device information; and
providing, with the circuitry, information to the output device to output audio based on the at least one audio processing parameter.
   (43)

An audio reproduction device, comprising:
circuitry configured to:
receive at least one audio processing parameter via a network;
process audio using the at least one audio processing parameter to generate processed audio; and
output the processed audio as sound,
wherein the at least one audio processing parameter is determined based on hearing aid fitting information and device information of the audio reproduction device.
   (44)

The audio reproduction device according to (43), wherein the circuitry is further configured to:
receive, from at least one sensor, situation information of a situation in which a user of the audio reproduction device is present; and
adjust the at least one audio processing parameter based on the situation information.

### REFERENCE SIGNS LIST

1, 5 Hearing aid system
2 Hearing aid
3 Charger
20, 20b, 20f, 200, 500 Sound collection unit
21 Signal processing unit
22, 43, 270, 570 Output unit
25, 32 Battery
26, 331 Connection unit
27, 30, 34, 42, 900 Communication unit
28, 35, 45, 920 Storage unit
29, 36, 46 Control unit
31, 44 Display unit
40 Information processing terminal
41 Input unit
47 Hearing aid fitting unit
48, 51, 918 Hearing aid processing unit
50, 50a, 50b, 50c. 50d Sound reproduction apparatus
52, 914 Parameter generation unit
60, 484 Communication network
90, 90a, 90b, 90c, 90d, 90e, 90f Server
201 Mic
202 A/D conversion unit
220, 520 Directivity processing unit
221 D/A conversion unit
222 Receiver
230, 530 Howling cancellation/suppression unit
240, 540 Noise suppression unit
250 Compressor
281, 351, 451 Program
282 Data
510, 560 Sensitivity/F characteristic correction unit
580 Scene detection unit
590 Parameter control unit
910 Processing unit
912 Acquisition unit
916 Output unit
922 Fitting data
924 Device information
1000 Edge region
1100 Sound production device
1200 Peripheral device
1300 Vehicle
1400 Other devices
2000 Cloud region
2100, 3200 Server device
3000 Business operator region
3100 Business operator
4000, 5000 Network

1. An information processing system, comprising:
circuitry configured to
acquire fitting data corresponding to a hearing aid;
acquire device information for an output device that at least outputs audio;
generate at least one audio processing parameter for the output device based on the fitting data and the device information; and
provide information to the output device to output audio based on the at least one audio processing parameter.

2. The information processing system according to claim 1, wherein the circuitry is further configured to transmit, as the information, the at least one audio processing parameter to the output device.

3. The information processing system according to claim 1, wherein the circuitry is further configured to:
process audio based on the at least one audio processing parameter; and
transmit, as the information, the audio, after processing with the at least one audio processing parameter, to the output device for output.

4. The information processing system according to claim 1, further comprising a storage circuit configured to store fitting data for a plurality of users, wherein the circuitry is further configured to acquire fitting data for a user of the hearing aid from the storage circuit.

5. The information processing system according to claim 4, wherein the circuitry is further configured to:
receive input of user identification information corresponding to the user of the hearing aid, and
acquire the fitting data for the user of the hearing aid from the storage circuit based on the user identification information.

6. The information processing system according to claim 1, wherein the circuitry is further configured to:
compare functionality of the hearing aid with corresponding functionality of the output device, based on the fitting data and the device information, and
generate, based on the comparison, the at least one audio processing parameter for the output device.

7. The information processing system according to claim 6, wherein the circuitry is further configured to:
compare at least one functional unit of the hearing aid with at least one corresponding functional unit of the output device based on functional configuration information of the hearing aid included in the fitting data and functional configuration information of the output device included in the device information, and
generate, based on a control parameter of the at least one functional unit of the hearing aid, the at least one audio processing parameter for the output device having a same resolution as a resolution of a control parameter of the at least one corresponding functional unit of the output device in a case that the control parameter of the at least one functional unit of the hearing aid and the control parameter of the at least one corresponding functional unit of the output device are of different resolutions.

8. The information processing system according to claim 7, wherein the circuitry is further configured to duplicate a value included in the control parameter of the at least one functional unit of the hearing aid to generate the at least one audio processing parameter for the output device in a case that the control parameter of the at least one functional unit of the hearing aid has a smaller resolution than the control parameter of the at least one corresponding functional unit of the output device.

9. The information processing system according to claim 7, wherein the circuitry is further configured to interpolate at least some values of the control parameter of the at least one functional unit of the hearing aid to generate the at least one audio processing parameter for the output device in a case that the control parameter of the at least one functional unit of the hearing aid has a smaller resolution than the control parameter of the at least one corresponding functional unit of the output device.

10. The information processing system according to claim 7, wherein the circuitry is further configured to generate an average of at least some values included in the control parameter of the at least one functional unit of the hearing aid to generate the at least one audio processing parameter for the output device having a same resolution as the control parameter of the at least one corresponding functional unit of the output device in a case that the control parameter of the at least one functional unit of the hearing aid has a greater resolution than the control parameter of the at least one corresponding functional unit of the output device.

11. The information processing system according to claim 6, wherein the circuitry is further configured to generate the at least one audio processing parameter for the output device according to performance of the hearing aid for a specific range of input.

12. The information processing system according to claim 1, wherein the fitting data includes at least an audiogram of a user of the hearing aid, and
the circuitry is further configured to generate the at least one audio processing parameter based on the audiogram and the device information.

13. The information processing system according to claim 1, wherein the fitting data includes at least one of noise suppression information of the hearing aid, directivity processing information of the hearing aid, compression information of the hearing aid, howling suppression information of the hearing aid, frequency characteristic information of the hearing aid, fitting adjustment information, and user auditory characteristic information.

14. The information processing system according to claim 1, wherein the fitting data includes an auditory characteristic model of a user obtained by machine learning, and
the circuitry is further configured to generate the at least one audio processing parameter based on the auditory characteristic model of the user.

15. The information processing system according to claim 1, wherein the device information includes at least one of device identification information of the output device, noise suppression information of the output device, directivity processing information of the output device, howling suppression information of the output device, compression information of the output device, and control information of the output device.

16. The information processing system according to claim 1, wherein the circuitry is further configured to output a plurality of audio processing parameters for user selection of at least a subset thereof.

17. The information processing system according to claim 1, further comprising a server to be connected with the hearing aid and the output device through a network,
wherein the server includes the circuitry.

18. The information processing system according to claim 17, further comprising a storage circuit configured to store fitting data for a plurality of users,
wherein the storage circuit and the server are connected through the network, and
the circuitry is further configured to acquire the fitting data for a user of the hearing aid from the storage circuit.

19. The information processing system according to claim 2, wherein the circuitry is further configured to encrypt the at least one audio processing parameter before transmitting the at least one audio processing parameter to the output device.

20. The information processing system according to claim 1, wherein the circuitry is further configured to generate a plurality of audio processing parameters for a plurality of different modes, the plurality of different modes include at least a mode for music reproduction and a mode for a spoken voice.

21. The information processing system according to claim 20, wherein, in the mode for a spoken voice, the circuitry is further configured to generate the at least one audio processing parameter based on a position of a user of the hearing aid.

22. An information processing method, comprising:
acquiring, with circuitry, fitting data corresponding to a hearing aid;
acquiring, with the circuitry, device information for an output device that at least outputs audio;
generating, with the circuitry, at least one audio processing parameter for the output device based on the fitting data and the device information; and
providing, with the circuitry, information to the output device to output audio based on the at least one audio processing parameter.

23. An audio reproduction device, comprising:
circuitry configured to:
receive at least one audio processing parameter via a network;
process audio using the at least one audio processing parameter to generate processed audio; and
output the processed audio as sound,
wherein the at least one audio processing parameter is determined based on hearing aid fitting information and device information of the audio reproduction device.

24. The audio reproduction device according to claim 23, wherein the circuitry is further configured to:
receive, from at least one sensor, situation information of a situation in which a user of the audio reproduction device is present; and
adjust the at least one audio processing parameter based on the situation information.
